(19) United States
(12) Patent Application Publication
(10) Pub. No.: US 2026/0127547 A1
(43) Pub. Date: May 7, 2026

(54) SYSTEMS AND METHODS FOR CONTROLLING RESOURCE ALLOCATION

(71) Applicant: CARUMAI, LLC, St. George, UT (US)

(72) Inventors: Herbert Ramon Anderson, Las Vegas, NV (US); Alison Thompson, St. George, UT (US); Taft Allan Thompson, St. George, UT (US); Jorge Jesus Gomez-Ramirez, St. George, UT (US); Diego Alberto Morfin, St. George, UT (US)

(21) Appl. No.: 19/437,170

(22) Filed: Dec. 30, 2025

Related U.S. Application Data
(63) Continuation-in-part of application No. 18/911,108, filed on Oct. 9, 2024.
(63) Continuation-in-part of application No. 18/911,129, filed on Oct. 9, 2024, now abandoned.
(60) Provisional application No. 63/589,919, filed on Oct. 12, 2023.
(60) Provisional application No. 63/589,921, filed on Oct. 12, 2023.
(60) Provisional application No. 63/589,923, filed on Oct. 12, 2023.
(60) Provisional application No. 63/589,919, filed on Oct. 12, 2023.
(60) Provisional application No. 63/589,921, filed on Oct. 12, 2023.
(60) Provisional application No. 63/589,923, filed on Oct. 12, 2023.

(51) Int. Cl. G06Q 10/087

(52) U.S. Cl. CPC G06Q 10/0877

(57) ABSTRACT

A system for controlling inventory-specific resource allocation comprises, for each particular inventory item of a set of inventory items: (i) determine a plurality of evaluation score deltas, each of the plurality of evaluation score deltas being associated with a respective inventory dimension of a plurality of inventory dimensions associated with the particular inventory item, the plurality of inventory dimensions comprising at least views and age; (ii) determine an evaluation score for the particular inventory item using the plurality of evaluation score deltas; (iii) determine an inventory resource allocation level for the particular inventory item based on the evaluation score; and (iv) automatically update resource allocation settings for the particular inventory item on one or more promotional communications platforms based on the inventory resource allocation level for the particular inventory item.

### CROSS-REFERENCE TO RELATED APPLICATIONS

This application is a continuation-in-part of U.S. patent application Ser. No. 18/911,108, filed Oct. 9, 2024, and entitled, “SYSTEMS AND METHODS FOR CONTROLLING RESOURCE APPLICATION,” and a continuation-in-part of U.S. patent application Ser. No. 18/911,129, filed Oct. 9, 2024, and entitled, “SYSTEMS AND METHODS FOR GENERATING AND PRESENTING USER INTERFACE FRONTENDS FOR FACILITATING SCORE-BASED INVENTORY-SPECIFIC RESOURCE ALLOCATION,” which claim priority to U.S. Provisional Patent Application No. 63/589,919, filed on Oct. 12, 2023, and entitled “SYSTEMS AND METHODS FOR FACILITATING MANAGEMENT OF VENDOR OPERATIONS”, and to U.S. Provisional Patent Application No. 63/589,921, filed on Oct. 12, 2023, and entitled, “SYSTEMS AND METHODS FOR FACILITATING INVENTORY ANALYSIS”, and to U.S. Provisional Patent Application No. 63/589,923, filed on Oct. 12, 2023, and entitled, “SYSTEMS AND METHODS FOR CONTROLLING INVENTORY-SPECIFIC EXPENDITURE”, the entirety of which are incorporated herein by reference for all purposes.

### BACKGROUND

Car dealerships face a range of challenges when it comes to marketing and advertising. For instance, many car dealerships collaborate with various marketing and/or advertising vendors (hereinafter “vendors”) to fulfill marketing/advertising needs vis-à-vis available inventory. However, analyzing and managing vendor relationships and/or operations can be a daunting task. Existing communication and/or analysis tools used between dealerships and vendors often fail to give dealerships a clear understanding of vendors' strategies, methodologies, specific services, and/or results. Dealerships thus often experience difficulty in determining return on investment (ROI) metrics associated with the vendor's marketing and advertising efforts. Such a lack of information can make it difficult for dealerships to keep vendors accountable for their performance and/or decisions, or to modify strategies/solutions to adapt to industry or market changes. Conventional tools can thus make it difficult for dealerships to ensure that campaigns are both effective and financially sustainable/sensible.

Dealerships also find difficulty in allocating advertising spending vis-à-vis available inventory. For instance, many existing advertising management tools make it difficult for dealerships to effectively account for fluctuating advertising costs, fees/commissions, market changes, and/or other factors. Furthermore, many existing advertising management tools fail to convey meaningful ROI information related to advertising spending, particularly on an inventory-specific basis. Existing advertising management tools can thus fail to enable dealerships to make well-reasoned decisions with respect to advertising spending. For example, a dealership may fail to throttle advertising spending for a piece of underperforming inventory (or a piece of inventory associated with low demand under current market conditions), which can result in wasted resources.

The subject matter claimed herein is not limited to embodiments that solve any challenges or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates example components of a system that may comprise or implement the disclosed embodiments.

FIG. 2 illustrates an example vendor overview section associated with a vendor report tool.

FIG. 3 illustrates an example real-time analytics section associated with a vendor report tool.

FIG. 4 illustrates a vendor display section associated with a vendor report tool.

FIGS. 5, 6, and 7 displays a vendor detail section associated with a vendor report tool.

FIG. 8 provides an alternative vendor overview section associated with a vendor report tool.

FIG. 9 provides an alternative vendor detail section associated with a vendor report tool.

FIG. 10 illustrates an example vendor data input section associated with a vendor report tool.

FIGS. 11-17 illustrate example aspects of a vendor database layout 1100 that can support components of a vendor report tool.

FIG. 18 illustrates a user interface frontend associated with an inventory analysis tool.

FIG. 19 illustrates an example views breakdown associated with an inventory analysis tool.

FIG. 20 illustrates an example leads breakdown associated with an inventory analysis tool.

FIG. 21 illustrates an example appointments breakdown associated with an inventory analysis tool.

FIG. 22 illustrates an example advertising cost breakdown associated with an inventory analysis tool.

FIG. 23 illustrates an example advertisement channel breakdown associated with an inventory analysis tool.

FIG. 24 illustrates example aspects of an advertisement dashboard.

FIG. 25 illustrates an example flow diagram depicting acts associated with controlling inventory-specific resource allocation.

FIG. 26 illustrates an example user interface frontend implemented as an advertisement spending management tool.

FIG. 27 illustrates an edit channel interface associated with an advertisement spending management tool.

FIG. 28 illustrates an example user interface frontend that provides controls for modifying various weights for determining evaluation score deltas associated with different inventory item dimensions.

### DETAILED DESCRIPTION

Disclosed embodiments are directed to systems, methods, apparatuses, and techniques for facilitating management of vendor operations, facilitating inventory analysis, and/or controlling inventory-specific expenditure. At least some disclosed embodiments may be implemented to assist automotive dealership personnel in comprehending, overseeing, and/or managing online dealership operations. Various features described herein may be implemented to facilitate management of third-party vendors, advertisements, and/or reviews, as well as to provide analytics on leads, appointments, website views, and/or other metrics.

At least some disclosed embodiments are directed to facilitating management of vendor operations. Various tools, features, techniques, components, and/or functionality related to management and/or analysis of vendor operations are sometimes described herein as aspects of a “vendor report”. A vendor report may comprise a versatile tool for managing and viewing third-party vendors. A vendor report may offer insights into expenses and performance associated with vendors for selected months or quarters. In some implementations, users can search and filter vendors by assignment, view descriptions of vendors, access historical activity data, see points of contact, and/or easily navigate to the vendor's website portal. A vendor report page may display costs, website views, vehicle detail page (VDP) views, leads, appointments, cost per view (CPV), cost per lead (CPL), cost per appointment (CPA), and/or other metrics associated with each vendor during the chosen time frame.

A vendor report, as described herein, may allow dealerships to more readily understand vendor strategies, actions, methodologies, specific services, results, and/or ROI metrics associated with vendor performance. Such functionality may be used by dealerships to adapt to keep vendors accountable, adapt to industry or market changes, and/or maintain communication/relationships with vendors.

At least some disclosed embodiments are directed to facilitating inventory analysis. Within the domain of car dealerships, various tools, features, techniques, components, and/or functionality related to inventory analysis are sometimes described herein as aspects of a “VIN dashboard”. A VIN dashboard may provide a comprehensive results page that can enable users to view their inventory in a filtered and sorted manner, along with extensive vehicle details. A VIN dashboard may provide relevant cost/expenditure information and/or performance/evaluation metrics on a per-vehicle basis (e.g., CPV, CPL, CPA), thereby enabling users to make informed decisions about inventory management strategy.

In some instances, a VIN dashboard provides an indication of auto-generated expenditure categories associated with particular pieces of inventory (e.g., vehicles). For instance, at least some disclosed embodiments are directed to controlling inventory-specific expenditure by utilizing a processing module (e.g., an artificial intelligence module, or other modeling structure comprising one or more machine learning algorithms installed thereon) to categorize or classify pieces of inventory into expenditure categories (“spend” categories) based on various inputs/factors (e.g., scarcity, fame, make, model, condition, color, views, leads, appointments, age). Spend categories may include, in one example, high spend, medium spend, low spend, and no spend categories/levels.

Spend categories may be utilized to automatically trigger different advertising expenditure levels for different pieces of inventory. For instance, users may define budgets for each spend category/level, which can influence advertising priorities and/or vehicle sorting. Such functionality can advantageously enable dealerships/users to avoid inefficient ad spending on pieces of inventory that are unlikely to yield a desirable return on advertising expenditure.

In some embodiments, additional information and/or functionality related to spend categories may be provided on an advertisement manager (or “ads manager”) platform, which may enable users to review information utilized to generate a spend category label and/or may enable users to override system-generated spend categories on an inventory-specific basis. For example, users may access, via an ads manager, reporting data pulled from a Google Ads API, a Facebook Marketing API, and/or information from other marketing platforms, which may enable users to monitor individual vehicle performance and track the number of vehicles sold over specific time ranges.

Although the present description focuses, in at least some respects, on implementations related to car dealerships, the principles described herein may be applied in other contexts/fields (e.g., real estate, heavy equipment/machinery, luxury goods, recreational vehicle, boats, etc.). For instance, a vendor report may be utilized to facilitate management of advertising/marketing vendors in any domain, and an inventory analysis tool similar to a VIN dashboard may be utilized to manage aspects of other types of inventory, and spend levels may be automatically determined/implemented for different types of inventory.

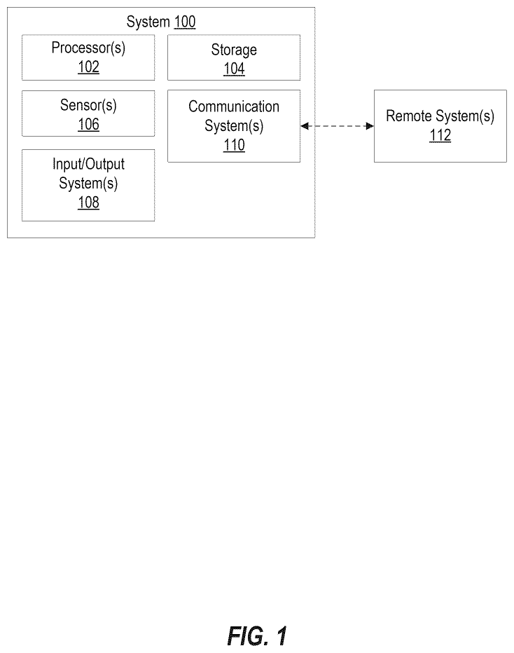

Attention is now directed to FIG. 1, which illustrates an example system 100 that may include or be used to implement one or more disclosed embodiments. The system 100 may comprise any type of device or set of devices, without limitation, such as a personal computer, laptop, tablet, smartphone, wearable device (e.g., head-mounted display, smartwatch), server, cloud infrastructure, and/or any other type of interface/computing/processing system(s).

FIG. 1 illustrates various example components of the system 100. For example, FIG. 1 illustrates an implementation in which the system includes processor(s) 102, storage 104, sensor(s) 106, I/O system(s) 108, and communication system(s) 110. Although FIG. 1 illustrates a system 100 as including particular components, one will appreciate, in view of the present disclosure, that a system 100 may comprise any number of additional or alternative components.

The processor(s) 102 may comprise one or more sets of electronic circuitries that include any number of logic units, registers, and/or control units to facilitate the execution of computer-readable instructions (e.g., instructions that form a computer program). Such computer-readable instructions may be stored within storage 104. The storage 104 may comprise computer-readable recording media and may be volatile, non-volatile, or some combination thereof. Furthermore, storage 104 may comprise local storage, remote storage (e.g., accessible via communication system(s) 110 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As will be described in more detail, the processor(s) 102 may be configured to execute instructions stored within storage 104 to perform certain actions. The actions may rely at least in part on data stored on storage 104 in a volatile or non-volatile manner. In some instances, the actions may rely at least in part on communication system(s) 110 for receiving data from remote system(s) 112, which may include, for example, separate systems or computing devices, sensors, and/or others. The communications system(s) 110 may comprise any combination of software or hardware components that are operable to facilitate communication between on-system components/devices and/or with off-system components/devices. For example, the communications system(s) 110 may comprise ports, buses, or other physical connection apparatuses for communicating with other devices/components. Additionally, or alternatively, the communications system(s) 110 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 1 illustrates that a system 100 may comprise or be in communication with sensor(s) 106. Sensor(s) 106 may comprise any device for capturing or measuring data representative of perceivable phenomena. By way of non-limiting example, the sensor(s) 106 may comprise one or more image sensors, microphones, thermometers, barometers, magnetometers, accelerometers, gyroscopes, and/or others.

Furthermore, FIG. 1 illustrates that a system 100 may comprise or be in communication with I/O system(s) 108. I/O system(s) 108 may include any type of input or output device such as, by way of non-limiting example, a touch screen, a mouse, a keyboard, a controller, and/or others, without limitation. For example, the I/O system(s) 108 may include a display system that may comprise any number of display panels, optics, laser scanning display assemblies, and/or other components.

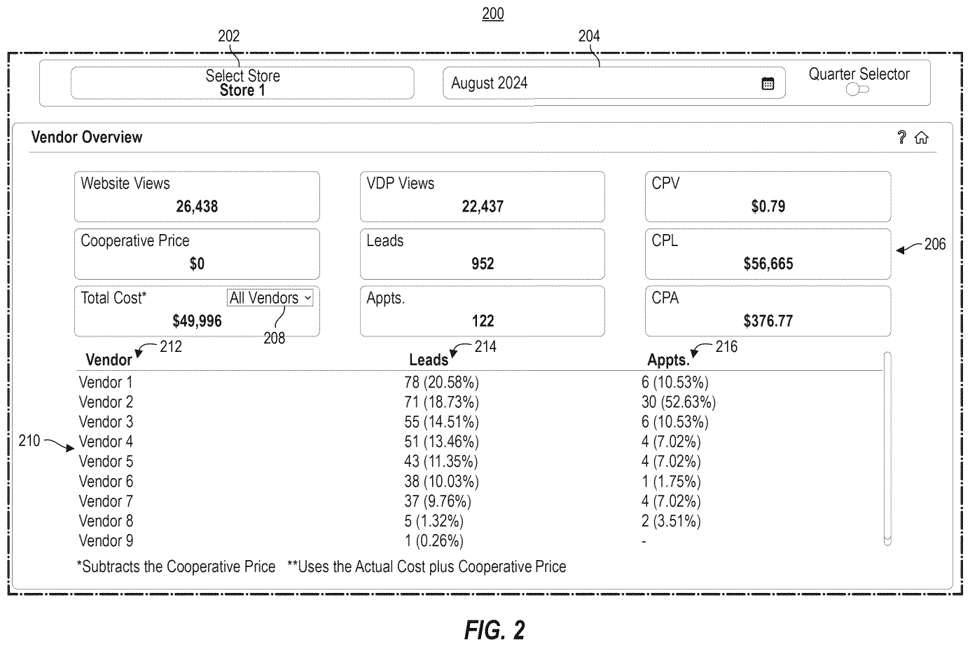

FIGS. 2-10 illustrate example aspects of a vendor report tool, in accordance with implementations of the present disclosure. A vendor report tool may comprise a user interface frontend that includes various sections, interfaces, pages, or components that can present information to users (e.g., visually or otherwise) and/or provide a framework for facilitating user interaction such as by receiving user input (e.g., providing input fields, selectable elements/controls/buttons, etc.). The vendor report tool can comprise an aspect of a software application (e.g., a locally stored and/or web-based application) that is executable using one or more components of a system 100 and/or remote system 112 (e.g., server). Although the sections, interfaces, or components of a vendor report tool are described herein with particular names (e.g., “Vendor Overview”, “Vendor Display”, “Vendor Data Input”), such names are not limiting of the principles described in association with the various sections, interfaces, or components.

FIG. 2 illustrates an example vendor overview section 200 associated with a vendor report tool. The vendor overview section 200 depicts the various vendors that service a particular store (e.g., a dealership, or a brand store associated with a dealership). FIG. 2 depicts a store selector 202, which may allow for selection of various stores (e.g., associated with a single dealership) to view vendor statistics associated with each store. FIG. 2 also depicts a time period selector 204 that can allow users to specify a specific time period for vendor metrics to be displayed in association with the store identified in the store selector 202. In the example of FIG. 2, the time period selector 204 may be utilized to select a particular month, range of months, quarter, or other temporal range.

The vendor overview section 200 of FIG. 2 provides a vendor metrics overview 206, which displays aggregate vendor metrics based on individual vendor metrics for the various vendors that serve the selected store over the selected time period. For instance, in the example of FIG. 2, the vendor metrics overview 206 includes aggregate metrics for all vendors that serviced the “Store 1” store for the month of August 2024, such as aggregate website views, VDP (vehicle detail page) views, CPV (cost per view), cooperative price, leads, CPL (cost per lead), total cost, appointments, and CPA (cost per appointment). One will appreciate, in view of the present disclosure, that additional or alternative aggregate vendor metrics may be displayed in a vendor metrics overview 206. Various aggregation methods may be employed to combine metrics of individual vendors to obtain the aggregate vendor metrics, sum, average, median, mode, maximum/minimum, range, count, frequency distribution, percentiles, weighted average, geometric mean, variance and/or standard deviation, correlation and/or covariance, and/or others.

In some instances, a user is able to selectively modify at least some aspects of the displayed aggregate metrics in the vendor metrics overview 206. For instance, the vendor metrics overview 206 of FIG. 2 provides a vendor selector 208 that enables users to select the set of vendors upon which the displayed total vendor cost will be based. Additional or alternative customization options may be utilized in a vendor metrics overview 206.

In the example of FIG. 2, the vendor overview section 200 furthermore provides vendor-specific metrics 210, which may display individual vendors that service the selected store in conjunction with individual vendor metrics for the individual vendor. In the example of FIG. 2, the vendor-specific metrics 210 are displayed via a data structure that shows vendor names 212 and, for each named vendor, leads 214 and appointments 216. In some implementations, the vendor-specific metrics 210 displays additional or alternative individual vendor metrics, such as total cost, website views, VDP views, CPV, CPL, CPA, and/or others.

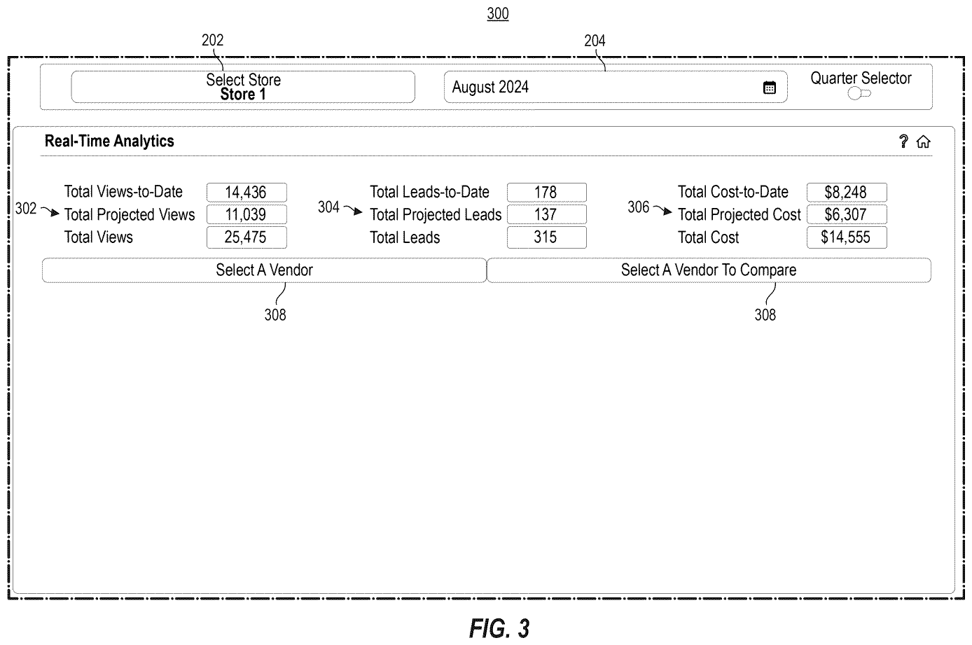

FIG. 3 illustrates an example real-time analytics section 300 associated with a vendor report tool. The real-time analytics section 300 can present vendor performance information for vendors associated with the store indicated by the store selector 202 and for the time period indicated by the time period selector 204. The vendor performance information can include, for example, views information 302, leads information 304, and cost information 306. The views information 302 can indicate, for the month or other time period selected via the time period selector 204, the total views-to-date, the total projected views (e.g., for the remainder of the month or other time period), and the total views (e.g., including the views-to-date and the projected views). Similarly, the leads information 304 can indicate, for the selected month/time period, the total leads-to-date, the total projected leads (e.g., for the remainder of the month or other time period), and the total leads (e.g., including the leads-to-date and the projected leads). Further, the cost information 306 can indicate, for the selected month/time period, the total cost-to-date, the total projected cost (e.g., for the remainder of the month or other time period), and the total cost (e.g., including the cost-to-date and the projected cost).

As shown in FIG. 3, the real-time analytics section 300 can additionally include vendor comparison tools, such as a vendor selection elements 308 that can facilitate user selection of different vendors (e.g., that service the same store selected via the store selector 202) to compare vendor metrics for the selected vendors, such as total cost, website views, VDP views, leads, appointments, CPV, CPL, CPA, and/or others.

In view of the foregoing, the vendor overview section 200 may be regarded as providing a store-centric representation of vendor metrics (e.g., showing metrics for vendors with respect to their servicing of a selected store). The vendor overview section can provide an organized and compact view of all (or any subset) of a selected store's vendors, which can be useful for store managers to readily ascertain and/or compare the performance of vendors for a specific store in the aggregate and individually. Such information can assist store managers in determining the effectiveness and/or ROI of vendor activity (e.g., by comparing different vendors to one another) and can facilitate performance comparisons across entire marketing portfolios.

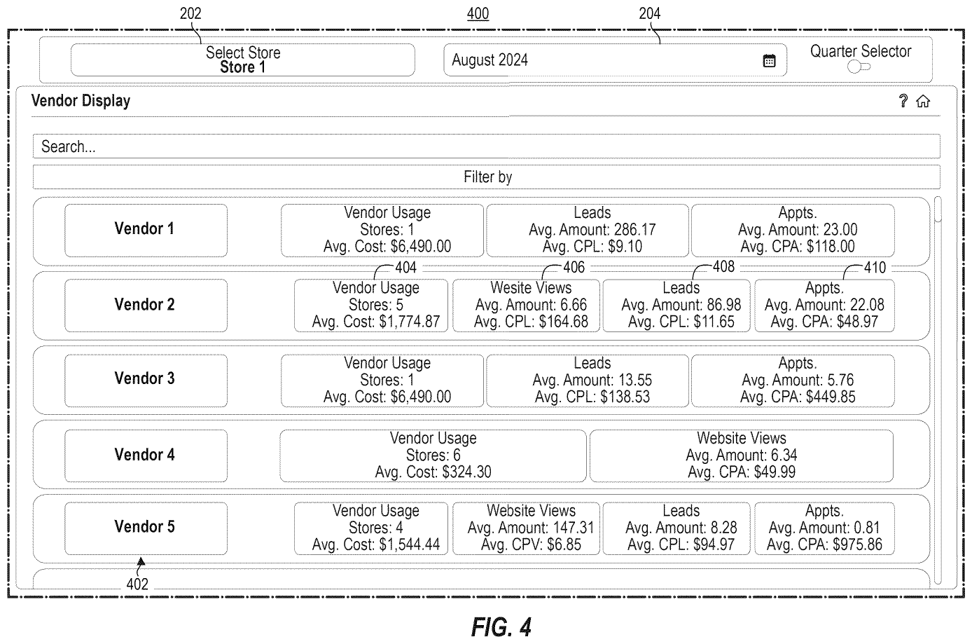

FIG. 4 illustrates a vendor display section 400 associated with a vendor report tool. In contrast with the vendor overview section 200, which can be regarded as displaying vendor metrics in a store-centric manner, the vendor display section 400 may be regarded as displaying vendor metrics in a vendor-centric manner (e.g., showing performance of each vendor with respect to its servicing of one or more stores). For instance, the vendor display section 400 of FIG. 4 depicts various individual vendors (e.g., vendors that service a group of stores or dealerships) and, for each individual vendor, can display vendor metrics aggregated from the individual vendor's performance across the various stores serviced by the individual vendor. In this way, the vendor display section 400 can illustrate how a single vendor performs across multiple stores.

In the example of FIG. 4, the vendor display section 400 includes a vendor list 402, which displays various vendors (e.g., vendors that service a group of stores or dealership) and vendor metrics for the displayed vendors based on the vendors' performance with respect to stores serviced by the vendors. For instance, the second entry in the vendor list 402 (from the top) is associated with the vendor “Vendor 2” and indicates vendor usage 404 for this vendor (e.g., 5 stores serviced, with an average cost of $1,774.87), website views 406 (e.g., averaging 6.66 views with a CPV of $164.68), lead metrics 408 (e.g., averaging 86.98 leads with a CPL of $11.65), and appointment metrics 410 (e.g., averaging 22.08 appointments with a CPA of $48.97). The metrics displayed may be bound to the same time period indicated by the time period selector 204 (which is still visible in the vendor display section 400 in the example of FIG. 4). The displayed metrics may be aggregated based on the vendor's performance across multiple stores. FIG. 4 illustrates that the vendor display section 400 can include different vendor metrics for different metrics (e.g., the first and third entries in the vendor list 402 omit website views details, and the fourth entry in the vendor list 402 omits leads and appointments details).

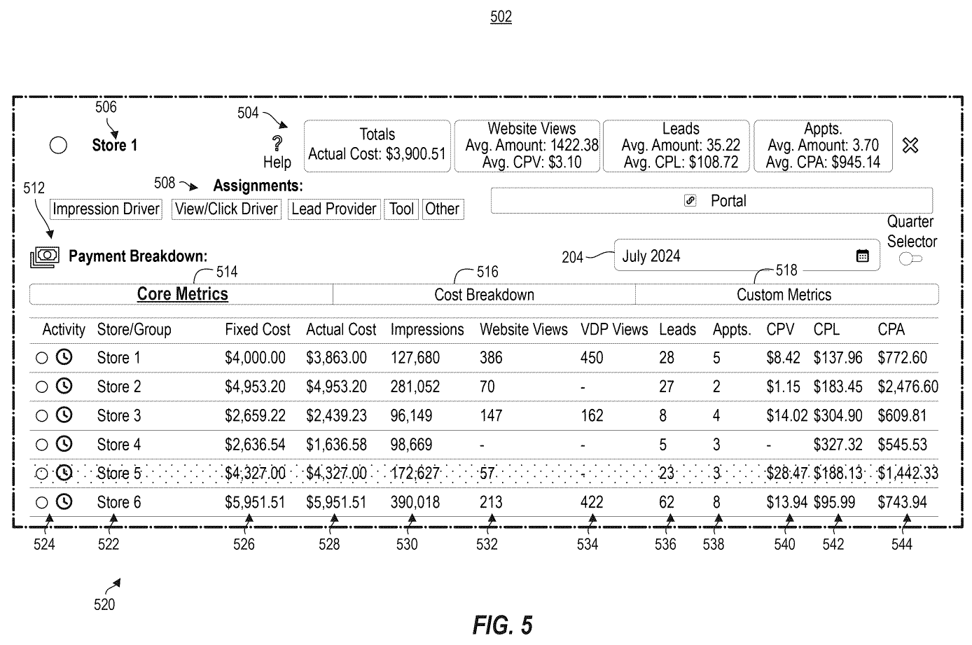

In some implementations, the vendor list 402 is interactable, enabling users to select particular listed vendors to access additional information related to the selected vendor. FIG. 5 displays a vendor detail section 502, which may be displayed after selection of a particular vendor from the vendor list 402 of FIG. 4. A vendor detail section 502 may display various information related to a vendor, such as aggregated vendor metrics 504 (also shown in the vendor list 402 as discussed above), vendor name 506 (e.g., in un-stylized form), vendor assignments 508 (e.g., indicating the role(s) performed by the vendor with respect to various stores), and a payment breakdown section 512. Additional sections are possible (e.g., a service description section describing the services performed by the vendor for one or more stores).

FIG. 5 illustrates additional details of the payment breakdown section 512. The information displayed in the payment breakdown section 512 may be constrained by the time period selector 204 (which can also be present in the payment breakdown section 512, as shown). The payment breakdown section 512 can enable users to readily compare/assess vendor performance with respect to different stores serviced by the vendor (e.g., providing a vendor-centric representation of vendor performance metrics/information). To this end, in the example of FIG. 5, the payment breakdown section 512 includes a core metrics section, a cost breakdown section, and a custom metrics section, which may be associated with selectable elements 514, 516, and 518, respectively, to allow users to toggle among these sections within the payment breakdown section 512.

FIG. 5 illustrates the payment breakdown section 512 with selectable element 514 selected/active, causing a core metrics section 520 to be surfaced. In the example of FIG. 5, the core metrics section 520 displays the particular stores/groups serviced by the applicable vendor and displays, for each particular store/group 522, activity 524 (e.g., indicating activity level of the interactions between the vendor and the store/group), fixed cost 526, actual cost 528, impressions 530, website views 532, VDP views 534, leads 536, appointments 538, CPV 540, CPL 542, and CPA 544.

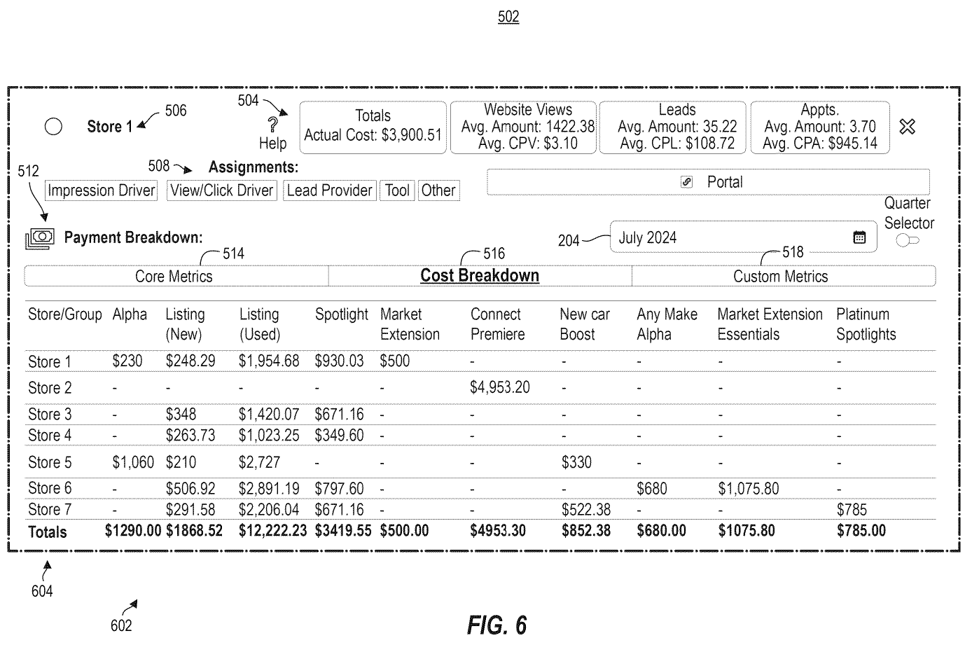

FIG. 6 illustrates the payment breakdown section 512 with selectable element 516 selected/active, causing a cost breakdown section 602 to be surfaced. In the example of FIG. 6, the cost breakdown section 602 also displays the particular stores/groups serviced by the applicable vendor and displays, for each particular store/group 604, metrics associated with marketing channels or platforms utilized by the vendor in servicing the particular stores/groups 604. For instance, in the cost breakdown section 602, each column following the store/group 604 column can indicate costs for different marketing products or services (e.g., Alpha, Listing (New), Listing (Used), Spotlight, Market Extension, Connect Premiere, New Car Boost, Any Make Alpha, Market Extension Essentials, Platinum Spotlights, etc.) offered by the vendor in servicing the various stores/groups.

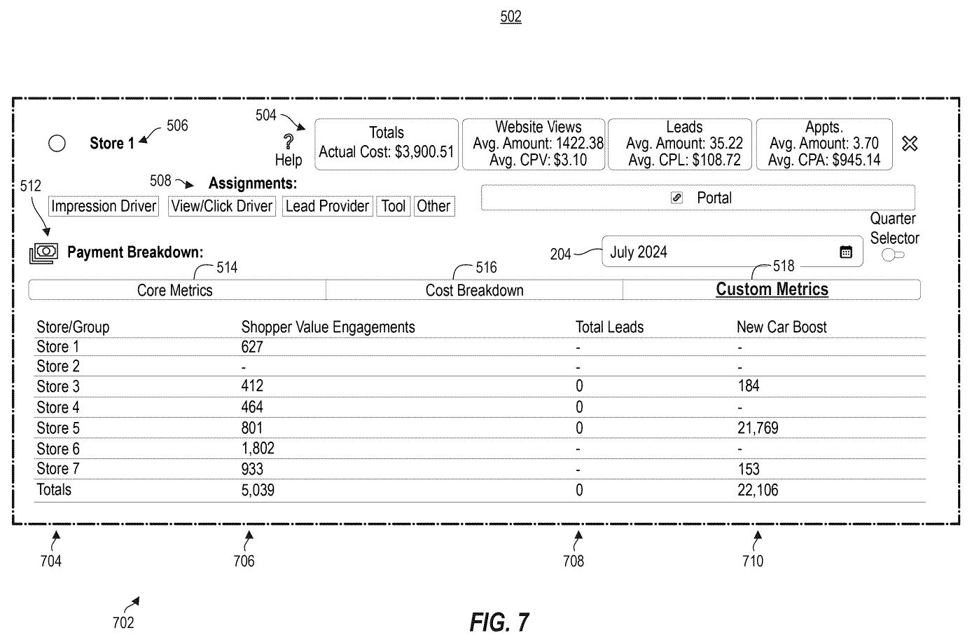

FIG. 7 illustrates the payment breakdown section 512 with selectable element 518 selected/active, causing a custom metrics section 702 to be surfaced. In the example of FIG. 7, the custom metrics section 702 also displays the particular stores/groups serviced by the applicable vendor and displays, for each particular store/group 704, other metrics associated with servicing of the store/group by the vendor. FIG. 7 illustrates these other metrics as including shopper value engagements 706, total leads 708, and new car boost 710, though other metrics may be included in a custom metrics section 702.

The metrics displayed in FIGS. 5, 6, and 7 may be bound to the same time period indicated by the time period selector 204 (which is still visible in association with the payment breakdown section 512 in the example of FIGS. 5, 6, and 7). The displayed metrics may be based on each vendor's performance with respect to the particular stores/groups listed. Such metric display functionality can enable store owners/managers to assess vendor performance across different stores and relative to other vendors. Such functionality can also enable users to have more intelligent conversations with their vendors without being forced to rely solely on information provided by vendors.

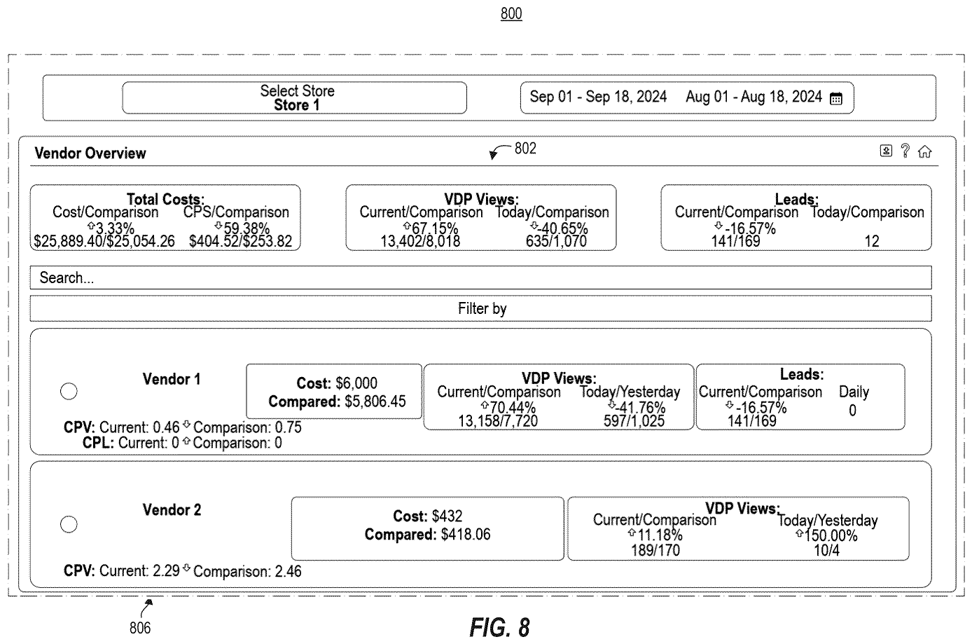

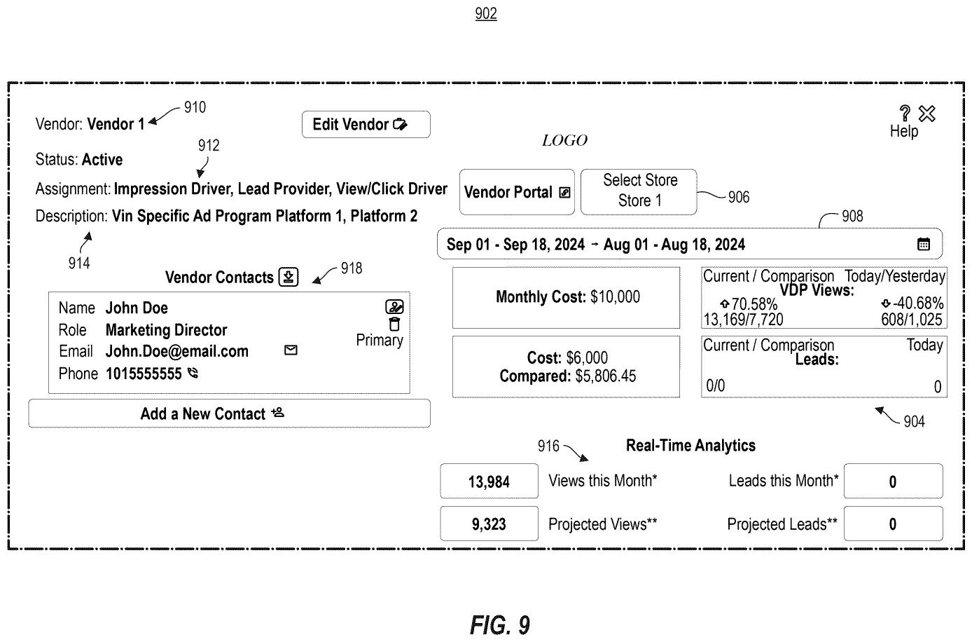

One will appreciate, in view of the present disclosure, that the organization and/or presentation of store-centric and/or vendor-centric information may be varied with respect to the specific examples described hereinabove. For instance, FIG. 8 provides an alternative vendor overview section 800 that includes an alternative vendor metrics overview 802 and includes aspects similar to the vendor display section 400 described hereinabove with reference to FIG. 4. For instance, the alternative vendor overview section 800 includes a vendor list 806 and displays, for each individual vendor, vendor metrics aggregated from the individual vendor's performance across various stores. As another example, FIG. 9 provides an alternative vendor detail section 902 that includes aggregated vendor metrics 904 for servicing a store selected via a store selector 906 and over a date range indicated by a time period selector 908. The alternative vendor detail section 902 also indicates the vendor name 910 (e.g., in un-stylized form), vendor assignments 912, service description 914, real-time analytics 916, and vendor contact information 918. The vendor contact information 918 can provide contact name information, role information, and/or contact mechanisms (e.g., call, email, and/or text selectable elements) to enable users associated with stores to readily ascertain relevant individuals associated with particular vendors, which can facilitate improved communication between store users and vendor individuals.

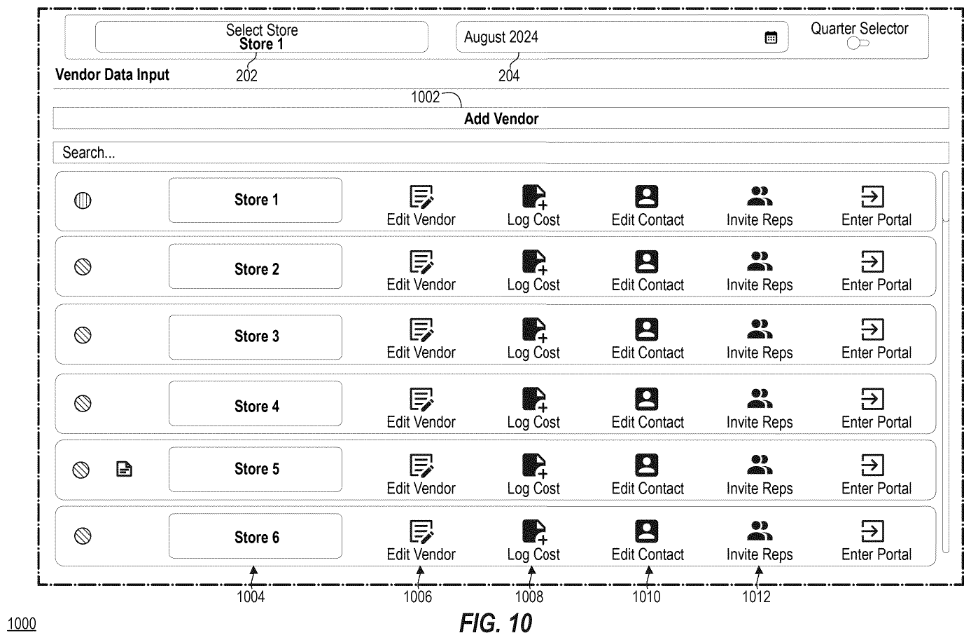

FIG. 10 illustrates an example vendor data input section 1000 associated with a vendor report tool. The vendor data input section 1000 may enable users to configure new vendors (e.g., via the “Add Vendor” selectable element 1002) for their vendor report tool and/or reconfigure existing vendors. For instance, the vendor data input section 1000 can include a vendor list 1004 that lists each vendor associated with a given store (indicated by the store selector 202) and provides various functions for each vendor such as editing vendor details (via selectable elements 1006), logging costs (via selectable elements 1008), editing contacts (via selectable elements 1010), inviting representatives (via selectable elements 1012), and/or others.

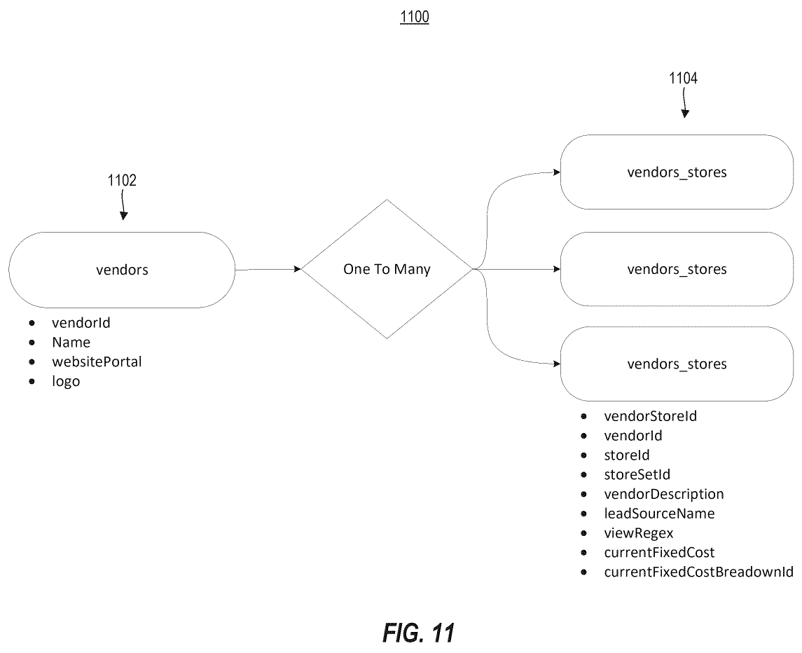

FIGS. 11-17 illustrate example aspects of a vendor database layout 1100 that can support components of a vendor report tool, as described hereinabove with reference to FIGS. 2-10. The vendor database layout 1100 of FIGS. 11-17 includes various data objects and indicates relationships or associations among such data objects. For instance, FIG. 11 illustrates vendor data objects 1102, which may be associated with various types of data entries including, but not limited to, vendor identifier (“vendorId”), name, website portal (“websitePortal”), logo, and/or others. FIG. 11 also conceptually depicts a one-to-many relationship between the vendor data objects 1102 and vendor stores data objects 1104. As used herein a one-to-many relationship may include one-to-one relationships or one-to-none relationships. FIG. 11 furthermore indicates that each vendor stores data object 1104 may be associated with various types of data entries, including, but not limited to, vendor-store identifier (“vendorStoreld”), vendor identifier (“vendorId”), store identifier (“storeld”), store set identifier (“storeSetId”), vendor description (“vendorDescription”), lead source name (“leadSourceName”), view regular expression (“viewRegex”), current fixed cost (“currentFixedCost”), current fixed cost breakdown identifier (“currentFixedCostBreakdownId”), and/or others.

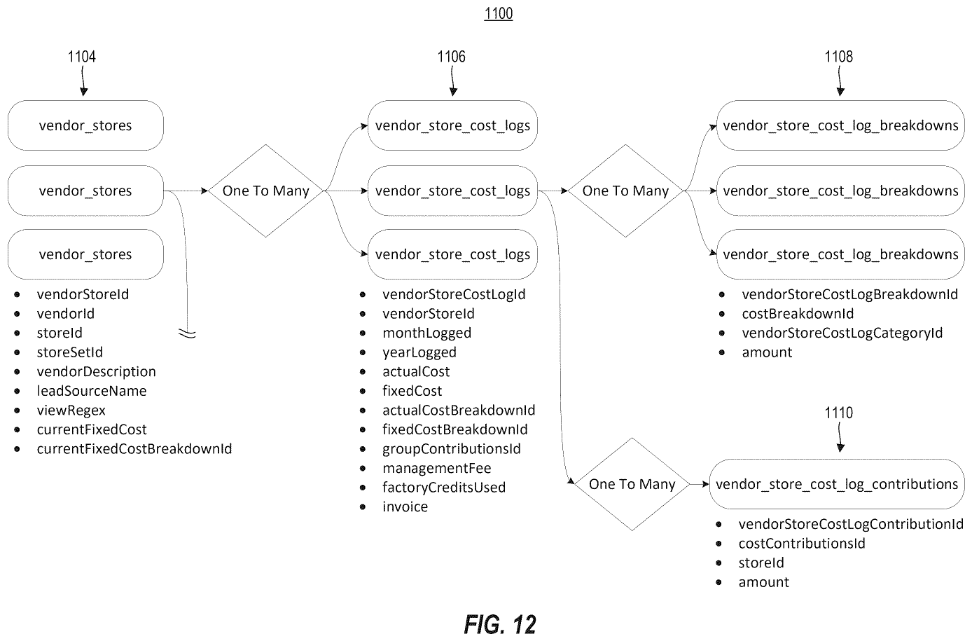

FIG. 12 illustrates additional aspects of the vendor database layout 1100. In particular, FIG. 12 conceptually depicts a one-to-many relationship between the vendor stores data objects 1104 and vendor store cost logs data objects 1106. FIG. 12 indicates that each vendor store cost logs data object 1106 may be associated with various types of data entries, including, but not limited to, vendor store cost log identifier (“vendorStoreCostLogld”), vendor store identifier (“vendorStoreId”), month logged (“monthLogged”), year logged (“yearLogged”), actual cost (“actualCost”), fixed cost (“fixedCost”), actual cost breakdown identifier (“actualCostBreakdownId), fixed cost breakdown identifier (“fixedCostBreakdownId”), group contributions identifier (“groupContributionsId”), management fee (“managementFee”), factory credits used (“factoryCreditsUsed”), invoice, and/or others.

FIG. 12 also conceptually depicts one-to-many relationships between the vendor store cost logs data objects 1106 and vendor store cost log breakdowns data objects 1108. FIG. 12 indicates that each vendor store cost log breakdowns data object 1108 may be associated with various types of data entries, including, but not limited to, vendor store cost log breakdown identifier (“vendorStoreCostLogBreakdownId”), cost breakdown identifier (“costBreakdownId”), vendor store cost log category identifier (“vendorStoreCostLogCategoryId”), amount, and/or others.

FIG. 12 furthermore conceptually depicts one-to-many relationships between the vendor store cost logs data objects 1106 and vendor store cost log contributions data objects 1110. FIG. 12 indicates that each vendor store cost log contributions data object 1110 may be associated with various types of data entries, including, but not limited to, vendor store cost log contribution identifier (“vendorStoreCostLogContributionld”), cost contributions identifier (“costContributionsId”), store identifier (“storeld”), amount, and/or others.

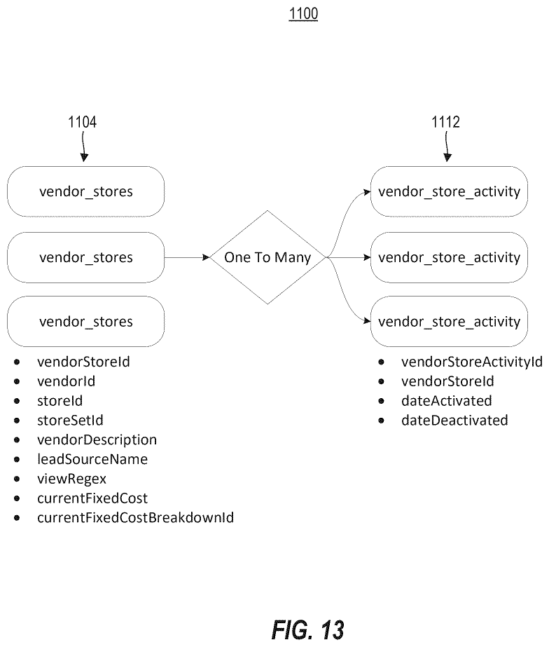

The vendor stores data objects 1104 have one-to-may relationships with additional or alternative types of data objects, as indicated in FIG. 12 by the break line extending from the vendor stores data objects 1104. FIG. 13 conceptually depicts one-to-many relationships between the vendor stores data objects 1104 and vendor store activity data objects 1112. FIG. 13 indicates that each vendor store activity data object 1112 may be associated with various types of data entries, including, but not limited to, vendor store activity identifier (“vendorStoreActivityId”), vendor store identifier (“vendorStoreId”), date activated (“dateActivated”), date deactivated (“dateDeactivated”), and/or others.

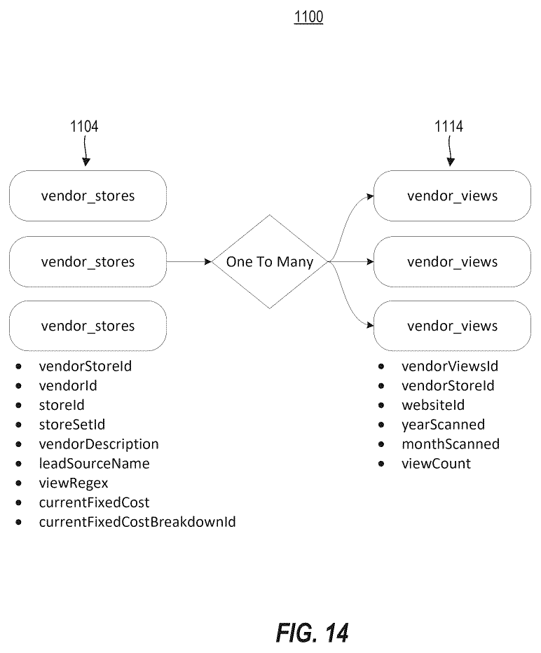

FIG. 14 conceptually depicts one-to-many relationships between the vendor stores data objects 1104 and vendor views data objects 1114. FIG. 14 indicates that each vendor views data object 1114 may be associated with various types of data entries, including, but not limited to, vendor views identifier (“vendorViewsId”), vendor store identifier (“vendorStoreId”), website identifier (“websiteIdentifier”), year scanned (“yearScanned”), month scanned (“monthScanned”), view count (“viewCount”), and/or others.

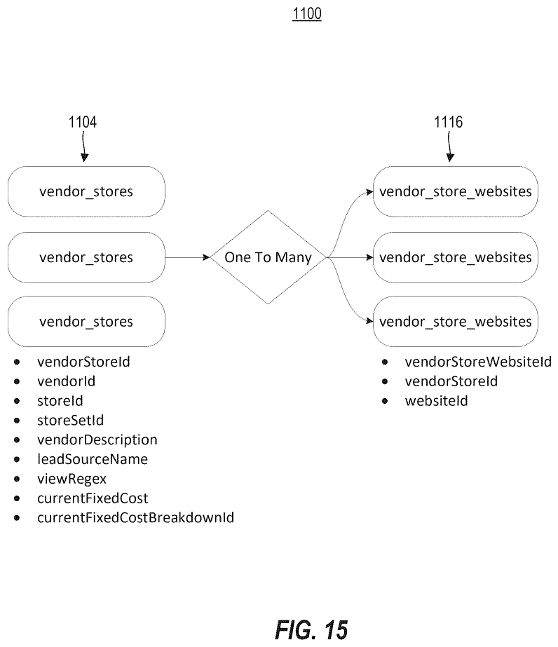

FIG. 15 conceptually depicts one-to-many relationships between the vendor stores data objects 1104 and vendor store websites data objects 1116. FIG. 15 indicates that each vendor store websites data object 1116 may be associated with various types of data entries, including, but not limited to, vendor store websites identifier (“vendorStoreWebsitesId”), vendor store identifier (“vendorStoreIdentifier”), website identifier (“websiteId”), and/or others.

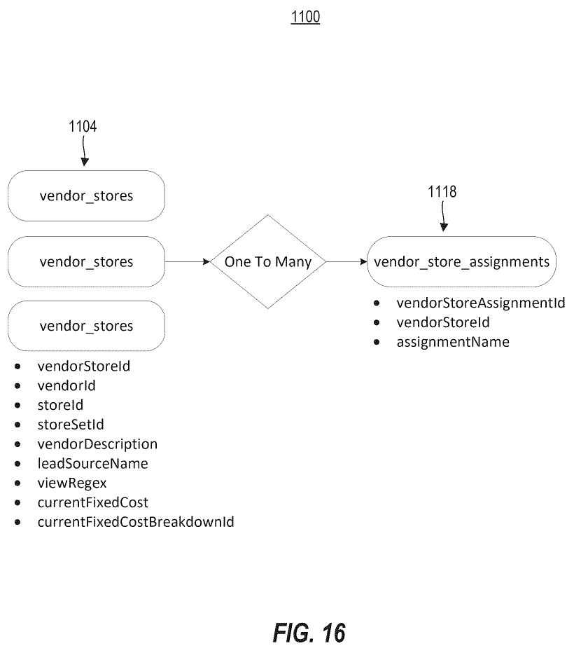

FIG. 16 conceptually depicts one-to-many relationships between the vendor stores data objects 1104 and vendor store assignments data objects 1118. FIG. 16 indicates that each vendor store assignments data object 1118 may be associated with various types of data entries, including, but not limited to, vendor store assignment identifier (“vendorStoreAssignmentId”), vendor store identifier (“vendor store identifier”), assignment name (“assignmentName”), and/or others.

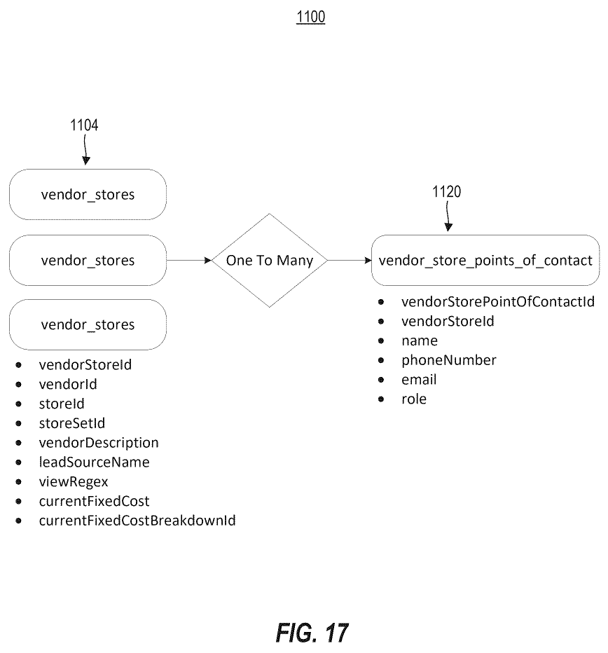

FIG. 17 conceptually depicts one-to-many relationships between the vendor stores data objects 1104 and vendor store points of contact data objects 1120. FIG. 17 indicates that each vendor store points of contact data object 1120 may be associated with various types of data entries, including, but not limited to, vendor store point of contact identifier (“vendorStorePointOfContactId”), vendor store identifier (“vendorStoreId”), name, phone number (“phoneNumber”), email, role, and/or others. Variations on the representations of the data object types and/or data entry types of the vendor database layout 1100 are within the scope of the present disclosure.

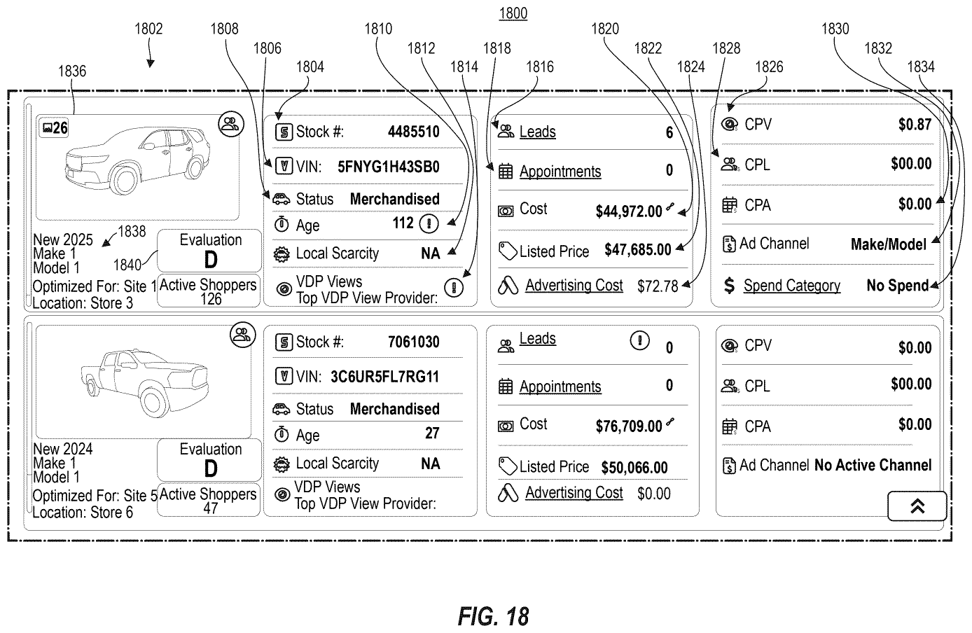

FIGS. 18-23 illustrate example aspects of an inventory analysis tool, referred to herein as a VIN dashboard 1800 in the context of automotive inventory. Similar to the vendor report tool described above, the inventory analysis tool can comprise a user interface frontend that is executable or presentable via one or more components of a system 100, remote system 112, etc. In the example of FIG. 18, the VIN dashboard 1800 provides a vehicle list 1802 that includes information for vehicles maintained in inventory, such as, by way of non-limiting example, stock number 1804, VIN 1806, status 1808, age 1810 (e.g., days listed or offered for sale), local scarcity 1812, VDP views 1814, leads 1816, appointments 1818, cost 1820, listed price 1822, advertising cost 1824, CPV 1826, CPL 1828, CPA 1830, advertisement channels 1832, spend category 1834, images 1836, vehicle specification 1838 (e.g., year, make, model, trim), and/or other information (e.g., location, quantity of active shoppers, optimized advertisement platform). The vehicles displayed in the vehicle list 1802 may be defined or constrained by a dealership selector, through which a user may select one or more dealerships to assess the inventory thereof. The VIN dashboard may include additional tools, such as a sort tool, a search tool, an export tool, and/or others, which may assist users in interpreting inventory status and/or finding particular inventory items.

FIG. 18 also illustrates the VIN dashboard 1800 as including an evaluation grade 1840, which may comprise a numerical, qualitative, or other type of score (e.g., letter grade scale, as shown in FIG. 18). The evaluation grade 1840 may be generated by one or more AI or other processing modules configured with one or more machine learning algorithms to utilize various cost metrics (e.g., advertising cost, invoice cost, reconditioning cost), result metrics (views, leads, appointments, CPV, CPL, CPA), and/or other information (e.g., status, age, scarcity) as inputs to determine marketing performance of a piece of inventory. For instance, an evaluation grade 1840 may be generated for a given inventory item based on an analysis of the age of the inventory item (e.g., whether the age meets or exceeds a turnover age or other age threshold), the views of the inventory item (e.g., whether the views accrued for the inventory item fails to satisfy a views threshold determined for the inventory item, as described in more detail hereinafter), the leads for the inventory item (e.g., whether the leads accrued for the inventory item fails to satisfy a leads threshold determined for the inventory item, as described in more detail hereinafter), the appointments for the inventory item (e.g., whether the appointments accrued for the inventory item fails to satisfy an appointments threshold determined for the inventory item, as described in more detail hereinafter), etc. The VIN dashboard 1800 can be configured to display one or more alerts based on metrics and/or other data associated with an inventory item. For instance, for the first inventory item in the vehicle list 1802 shown in FIG. 18, the age 1810 includes an alert (represented as an exclamation mark symbol), indicating that the age of the inventory item exceeds a predefined turnover age (e.g., 30 days, 60 days, etc.). The vehicle list 1802 also shows an alert associated with the VDP views 1814 for the first listed inventory item, indicating that the views accrued for the inventory item falls short of a views threshold determined for the inventory (e.g., an expected quantity of views based on the age of the inventory item, as described in more detail hereinafter). The VIN dashboard 1800 can additionally or alternatively display other alerts, which may be triggered when other metrics satisfy predefined thresholds (e.g., when CPV exceeds a predetermined range). Such functionality can enable users to readily ascertain potential problem areas associated with particular pieces of inventory (e.g., in a VIN-specific manner).

In some implementations, a VIN dashboard 1800 is configured to present recommendations to users based on input metrics and/or other data for the inventory items represented therein. By way of illustrative example, the VIN dashboard 1800 may display recommendation output based on a comparison between an estimated market value and a listed price for a piece of inventory. In such a case, the recommendation output may display a quantification or indication of a discrepancy between the estimated market value and the listed price for a piece of inventory, as well as recommended action based on the discrepancy (e.g., changing price to reflect estimated market value).

As noted above, the VIN dashboard 1800 may include a spend category 1834, as shown in FIG. 18. The spend category 1834 may comprise a numerical or qualitative label (e.g., a category classification, such as high spend, medium spend, low spend, no spend, etc.) indicative of a level of spending (e.g., on promotional communications platforms) to be expended on a piece of inventory. The spend category 1834 may be determined utilizing one or more AI modules or other processing techniques, as will be described in more detail hereinbelow. In some instances, a system is configured to automatically update the spend category 1834 (e.g., on a per-VIN basis) at regular intervals (e.g., daily, weekly, monthly, etc.). Users may define or confirm spending ranges associated with different spend categories, thereby facilitating automatic, data-driven modification of advertising spending on a per-VIN basis. Users may, in some instances, override automatically selected spend category settings, as will be described hereinbelow.

In some instances, a VIN dashboard 1800 may enable users to drill down on certain information shown for vehicles in a vehicle list 1802. In the example of FIG. 18, the VDP views 1814, leads 1816, appointments 1818, advertising cost 1824, advertisement channels 1832, and spend category 1834 are presented as selectable elements, which, if selected, can trigger display of breakdown information for these information categories.

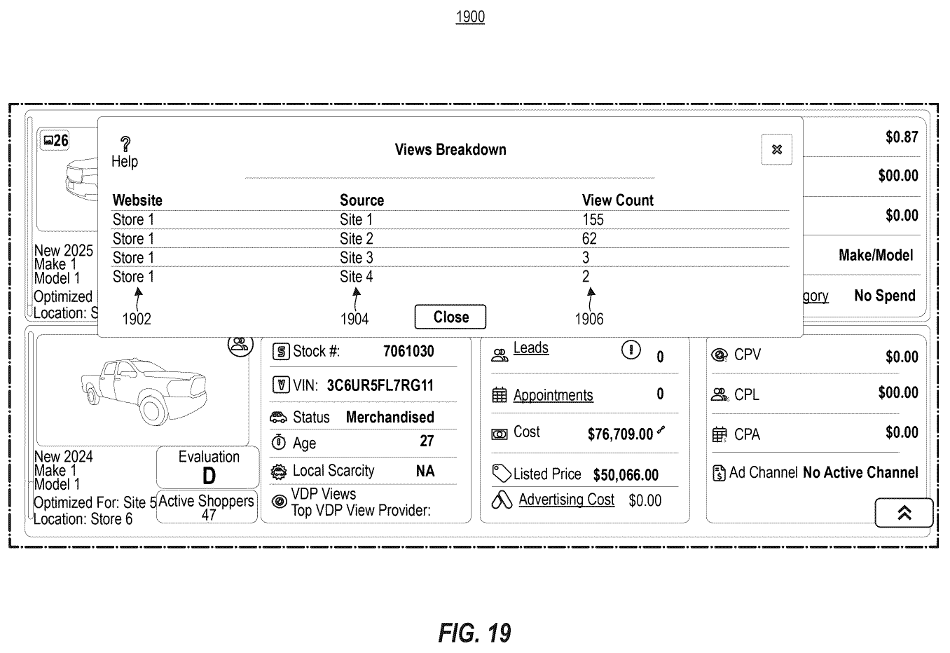

FIG. 19 illustrates an example views breakdown 1900, which may be displayed after selection of the VDP views 1814 element associated with a particular vehicle in the vehicle list 1802 of the VIN dashboard 1800. The views breakdown 1900 may detail the websites 1902 where views occurred, the views source 1904, and the view count 1906 (and/or other metrics such as total views, which may be presented in both the views breakdown 1900 and the vehicle list 1802).

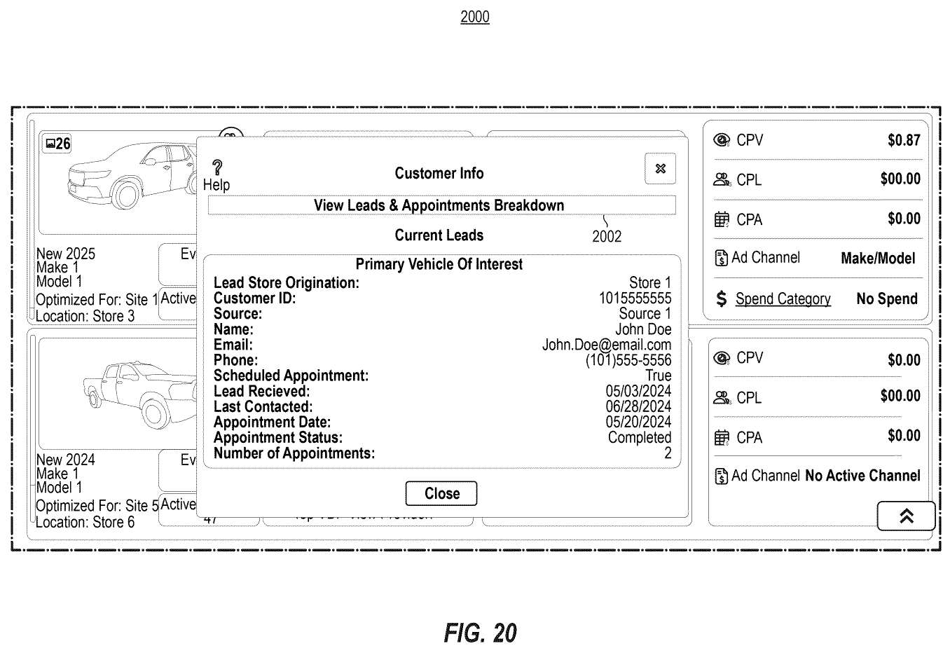

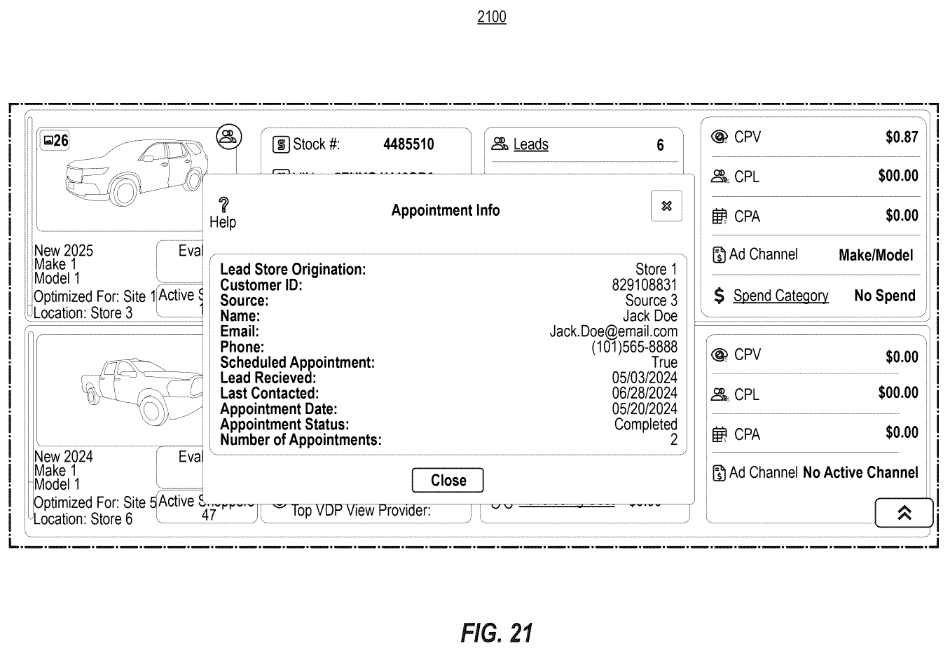

FIG. 20 illustrates an example leads breakdown 2000, which can provide information associated with leads accrued for a given inventory item. The leads breakdown 2000 may be displayed after selection of the leads 1816 element associated with a particular vehicle in the vehicle list 1802. For instance, the leads breakdown can indicate information for each lead, such as lead store origination, customer ID, source, name, email, phone, whether an appointment has been scheduled, lead reception date, date of last contact, appointment date, appointment status, number of appointments, etc. FIG. 21 illustrates an example appointments breakdown 2100, which can include information similar to that of the leads breakdown and can be displayed after selection of the appointments 1818 element of a particular inventory item of the vehicle list 1802. The leads breakdown 2000 of FIG. 20 also provides a selectable element 2002 through which a user can access a leads and appointments breakdown, which can list sources of leads and appointments and can indicate, for each source, the quantity of leads and/or appointments generated (as well as total lead/appointment counts).

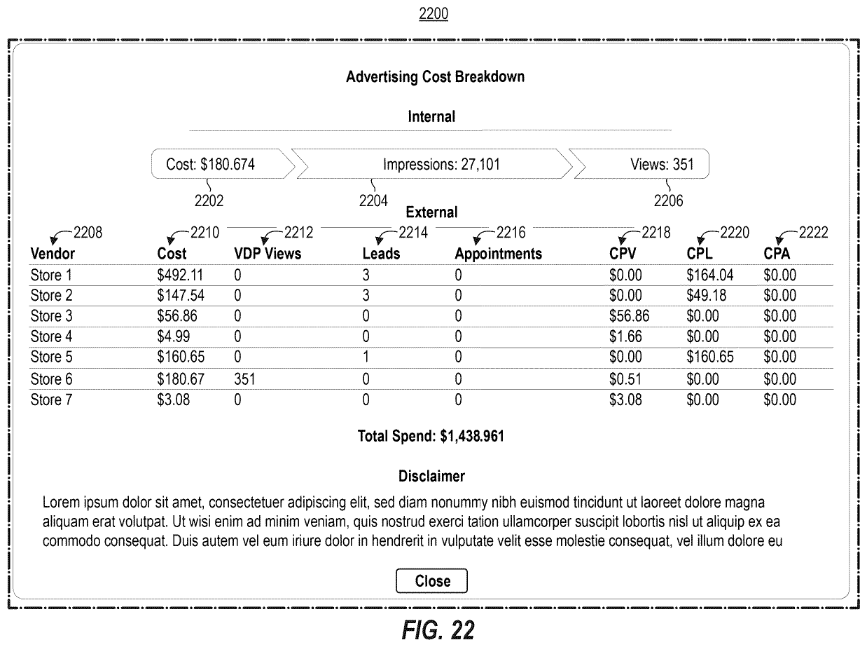

FIG. 22 illustrates an example advertising cost breakdown 2200, which may be displayed after selection of the advertising cost 1824 element associated with a particular vehicle in the vehicle list 1802. The advertising cost breakdown 2200 may provide internal advertising costs and/or results, such as internal cost 2202, impressions 2204, views 2206, etc. The advertising cost breakdown 2200 may additionally or alternatively provide external advertising costs and/or results, which may be provided in a vendor-specific manner (for the particular vehicle of the vehicle list 1802 for which the advertising cost 1824 element was selected). For instance, the advertising cost breakdown 2200 may provide a vendor list 2208 and, for each vendor, cost 2210, VDP views 2212, leads 2214, appointments 2216, CPV 2218, CPL 2220, and CPA 2222. The advertising cost breakdown 2200 may provide a total spend metric 2224 that aggregates internal spending and external spending (e.g., the total may be displayed on the vehicle list 1802).

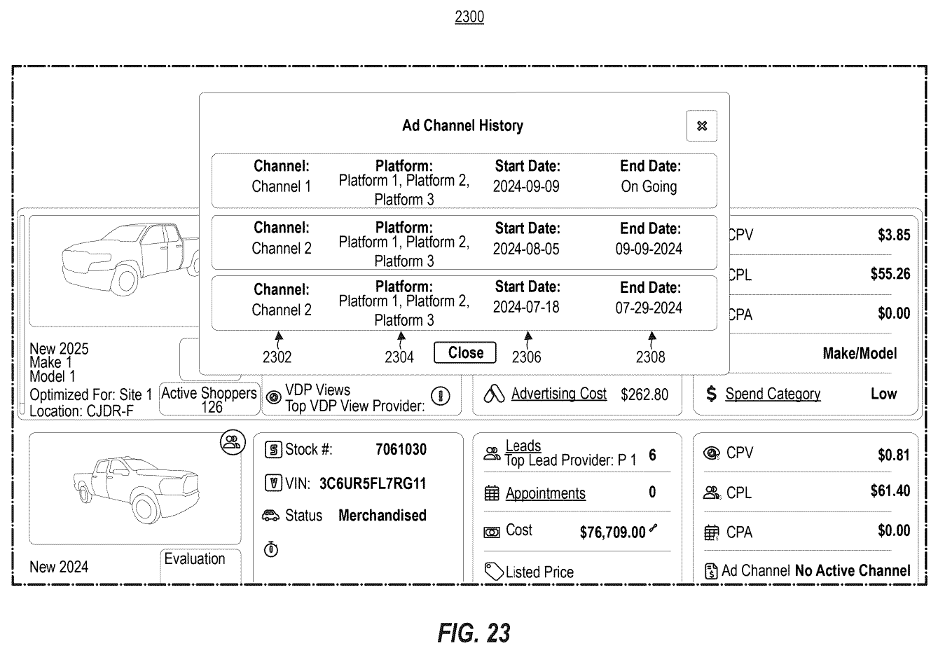

FIG. 23 illustrates an example advertisement channel breakdown 2300, which may be displayed after selection of the advertisement channels 1832 element associated with a particular vehicle in the vehicle list 1802. The advertisement channel breakdown 2300 can indicate historical advertising activity associated with the particular vehicle, such as the advertisement channel 2302 (e.g., spend category), platforms 2304 (e.g., promotional communications platforms), and start date 2306 and end date 2308 of each advertisement deployment.

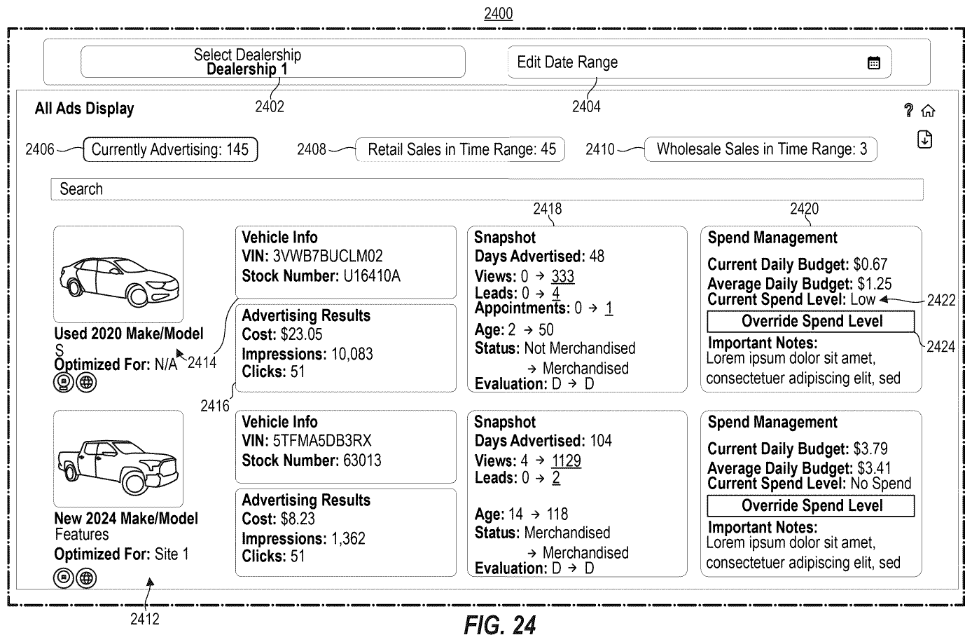

FIG. 24 illustrates example aspects of an advertisement dashboard 2400. The advertisement dashboard 2400 can comprise a user interface frontend that provides information related to advertisement efforts, settings, and/or results associated with one or more dealerships (which may be selected via a dealership selector 2402) and/or a time period (which may be selected via a time period selector 2404). The advertisement dashboard 2400 may provide overview information, such as vehicles currently advertised 2406, retail sales in time range 2408 (e.g., 30 days, 60 days, etc.), wholesale sales in time range 2410, etc. The advertisement dashboard 2400 may furthermore provide a vehicle listing 2412, which lists vehicles associated with the selected dealership and, for each vehicle, identifying information 2414 (e.g., VIN, stock number, vehicle specification, new/used), advertising results 2416 (e.g., advertising cost, impressions, clicks), an advertising snapshot 2418 (e.g., days advertised, views, leads, appointments, age, status, evaluation grade), and/or spend management 2420. The spend management 2420 of the advertisement dashboard 2400 can indicate various advertisement expenditure (or resource allocation) metrics such as current daily budget and average daily budget. The spend management 2420 can additionally indicate a current spend level 2422 (or spend category), which may comprise a category that indicates an amount or range of advertising spending permitted to be spent on a particular inventory item. In some instances, as noted above, the spend level 2422 is automatically determined via one or more AI or other processing modules. In some instances, the spend level 2422 is manually selected via user input (e.g., via an override control 2424). A spend level 2422 may comprise numerical or qualitative/categorical values. Spending ranges may be assigned to different spend levels 2422, allowing users to easily and/or automatically control advertising spending on a per-VIN basis.

To facilitate generation of spend category labels for association with particular inventory items (e.g., vehicles), a system may utilize one or more AI or other processing modules to sort vehicles into different spend levels/categories. As used herein, AI module(s) may include any number of processing layers/blocks/functions, as described hereinabove, as well as upstream or downstream functions/operations.

To determine a spend category label for a vehicle, the AI module(s) may utilize a plurality of inputs associated with the vehicle, such as, by way of non-limiting example, scarcity, fame (e.g., a vehicle popularity score), make, model, condition, color, views, leads, appointments, age (e.g., days on lot), combinations thereof, and/or others. Such inputs may be regarded as dimensions (e.g., in a multi-dimensional vector). The inputs may be assigned respective weights. In some instances, the weights are at least partially user-influenced (e.g., via the advertisement dashboard 2400). In some instances, the weights are at least partially automatically modified or determined/selected based on market conditions/data and/or other factors.

In at least one embodiment, to sort vehicles into spend categories (or assign spend categories to vehicles), each input vehicle may be assigned a static initial evaluation score. For each vehicle, the associated vehicle dimensions (e.g., input dimensions) may be processed by an evaluation function that utilizes, for each vehicle dimension, the value of the vehicle dimension and the weight associated with the vehicle dimension. In some instances, to process a particular vehicle dimension, the evaluation function utilizes values and/or weights associated with multiple vehicle dimensions (e.g., in the case of views, multiple vehicle dimensions may be used for evaluation, such as views accrued and age).

In this way, an evaluation score delta may be obtained via the evaluation function for each vehicle dimension of each vehicle. For each vehicle, the evaluation score deltas (for each dimension) and the static initial evaluation score may be aggregated (e.g., by summation). The aggregation result (e.g., a final evaluation score) may then be used to assign the vehicle to a spend category. For instance, the aggregation result may be compared to a set of score ranges, where each score range is associated with a respective spend category. The spend category associated with the score range in which the aggregation result falls may then be assigned to the vehicle. Such a process may be performed for any set of vehicles at any desired cadence (e.g., daily, weekly, monthly, etc.), and can therefore be used to sort the set of vehicles into different spend categories and/or regularly update the spend categories for the set of vehicles.

In some instances, vehicles are subjected to one or more threshold determinations or filtering operations prior to attempting to assign the vehicle to a spend category as described above. For instance, prior to assigning a spend category to a vehicle, a system may first determine whether advertising spending has already exceeded a predetermined budget for the vehicle. In such instances, a system may refrain from processing the vehicle as described above to determine a spend category therefor and instead assign the vehicle to a “no spend” category.

As another example, prior to assigning a spend category to a vehicle, a system may initially determine whether the vehicle is ready for marketing by examining relevant vehicle dimensions (e.g., a vehicle could fail to qualify for spend category assignment if the vehicle does not have an assigned price, or if the vehicle only has stock photos associated therewith, etc.). Such pre-processing may indicate action items needed to prepare a vehicle for spend category assignment. Such action items may be logged into a database for presentation on a VIN dashboard (or other) user interface. Vehicles that are not ready for marketing (as indicated by such pre-processing) may be removed from the advertising pool (e.g., causing the system to selectively refrain from assigning a spend category to such vehicles). Other initial or threshold determinations that precede a spend category assignment process may be utilized in accordance with the principles disclosed herein.

Spend categories assigned to particular vehicles may be presented in an advertisement dashboard 2400 on a per-vehicle basis (e.g., spend level 2422, as described above). Spend categories may additionally or alternatively be presented in a VIN dashboard 1800 (e.g., spend category 1834, as described hereinabove). As noted above, a user may override spend categories determined by a system (e.g., utilizing override controls 2424).

The per-vehicle spend category output (e.g., a list of vehicles sorted by spend category) may be utilized to algorithmically create advertisements, update/modify advertisements, and/or delete advertisements. Such dynamic advertisement control may be managed utilizing promotional communications platform APIs (e.g., Google Ads API, Facebook Marketing API). Promotional communications platform APIs may additionally be utilized to pull live impressions, clicks, and other metrics for presentation on an advertisement dashboard 2400 (or other frontend interface(s)).

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed. Implementations of the presently disclosed subject matter may omit or skip one or more of the method acts described herein. Operations associated with the method acts described herein may be performed using one or more components of one or more systems 100, remote systems 112, etc.

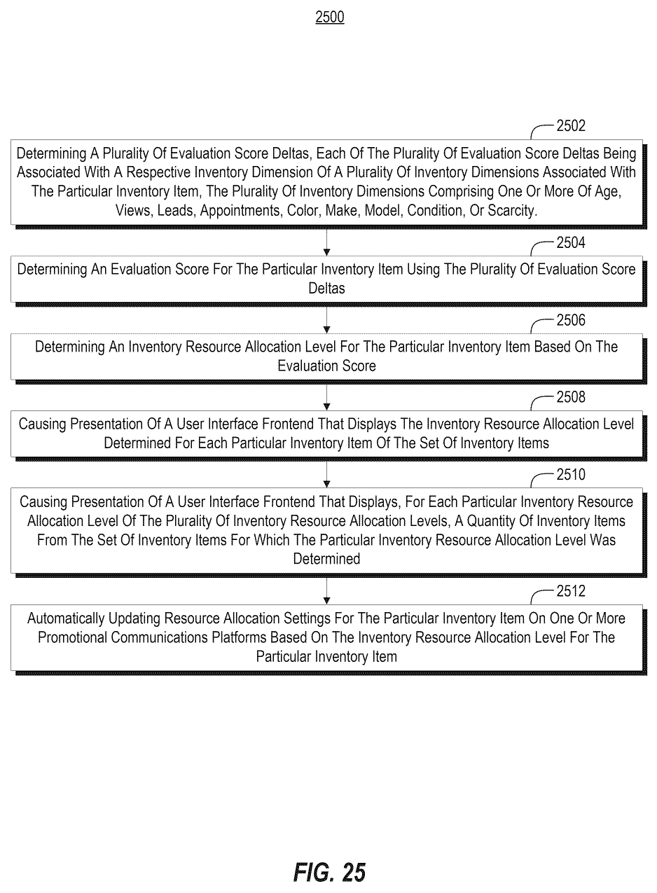

FIG. 25 illustrates an example flow diagram 2500 depicting acts associated with controlling inventory-specific resource allocation. The acts described in flow diagram 2500 may be performed for each particular inventory item (e.g., vehicle, real estate, or any item) of a set of inventory items (e.g., a set of vehicles available at one or more stores) at any desired cadence (e.g., hourly, daily, weekly, monthly, etc.).

Act 2502 of flow diagram 2500 includes determining a plurality of evaluation score deltas, each of the plurality of evaluation score deltas being associated with a respective inventory dimension of a plurality of inventory dimensions associated with the particular inventory item, the plurality of inventory dimensions comprising one or more of age, views, leads, appointments, color, make, model, condition, or scarcity. In this regard, the plurality of evaluation score deltas can include an age evaluation score delta, a views evaluation score delta, a leads evaluation score delta, an appointments evaluation score delta, a color evaluation score delta, a make evaluation score delta, a model evaluation score delta, a condition evaluation score delta, and/or a scarcity evaluation score delta. Example processes for determining each of these evaluation score deltas will now be provided.

An age evaluation score delta may be defined based on the age for the particular inventory item and an age weight. The age for the particular inventory item may indicate an amount of time that the particular inventory item has been listed or offered for sale (or can indicate another relevant temporal duration for the particular inventory item). In some implementations, for the purpose of determining the age evaluation score delta (and/or other evaluation score deltas described herein) the age for the particular inventory item can be constrained to not exceed a threshold value (e.g., an age effectiveness threshold), such that when the age of the particular inventory item satisfies the threshold value, marginal increases in age no longer affect the calculation of the age evaluation score delta. For instance, if the age for the particular inventory item is determined to satisfy (e.g., meet or exceed) the age effectiveness threshold, the age may be set to the age effectiveness threshold, otherwise the age for the particular inventory item may remain unmodified. The age effectiveness threshold can be tailored to different implementations (e.g., within a range of 30 to 120 days, or another amount of time).

The age weight can modify the importance or contribution of the age of the particular inventory item to the determination of the age evaluation score delta. In some instances, the age weight is selected based on a comparison of the age of the particular inventory item to a turnover age threshold. The turnover age threshold can indicate an amount of time in which an inventory item is desired or expected to cycle out of inventory (e.g., sell). The turnover age threshold can be tailored to different implementations (e.g., within a range of 15 to 60 days, or another amount of time). In one example, if the age for the particular inventory item is determined to fail to satisfy (e.g., be less than) the turnover age threshold, the age weight may be set to a first value (e.g., within a range of 1 to 4, or another range of values), otherwise the age weight may be set to a second value (e.g., within a range of 0.25 to 1, or another range of values).

By way of illustrative example, the age evaluation score delta may be determined as follows:

$${Δ}_{age} = a * {w}_{age} \qquad ( 1 )$$

where Δ_{age} represents the age evaluation score delta, a represents the age of the particular inventory item, and Wage represents the age weight.

A views evaluation score delta may be determined by using the age for the particular inventory item to determine a views threshold. The views threshold can represent a quantity of views (e.g., website views or other types of viewings of the particular inventory item) that the particular inventory item is expected or desired to have based on its age. Aside from age, the views threshold can additionally or alternatively be based on other metrics, data, or information associated with the particular inventory item, such as an expected views metric, a fame score, and/or others. The expected views metric can indicate a quantity of views that the particular inventory item is expected or desired to have over the turnover age threshold. The expected views metric can be tailored to different implementations (e.g., within a range of 104 to 416 views, or another range of values).

In some cases, inventory items associated with higher fame experience more views in order to become sold (e.g., because users often view such inventory items without intent to purchase). Thus, a fame score can modify the views threshold to account for such occurrences. The fame score can be determined based on one or more specifications of the particular inventory item. In one example, the fame score is determined based on the make and model of the particular inventory item. For instance, the fame score can comprise an aggregation (e.g., sum) of a make fame score and a model fame score, where the make fame score is based on a make fame weight and a make fame scaler, and where the model fame score is based on a model fame weight and a model fame scaler (as described below).

In some implementations, the views threshold is determined based on whether the age for the particular inventory item satisfies the turnover age threshold. In one example, if the age for the particular inventory item fails to satisfy the turnover age threshold, the views threshold may be determined based on a function of the age for the particular inventory item (e.g., a polynomial function of age), such as by:

$${T}_{views} = - ( \frac{( a - {a}_{turnover} ) ( a - {a}_{turnover} )}{{w}_{views - default}} ) + {v}_{expected} + {S}_{fame} \qquad ( 2 )$$

where T_{views} represents the views threshold, a represents the age for the particular inventory item, aₜᵤᵣₙₒᵥₑᵣ represents the turnover age threshold, w_{views-default} represents a default views weight (e.g., within a range of 6 to 24, or another range of time), v_{expected} represents the expected views metric, and S_{fame} represents the fame score. Continuing with the foregoing example, if the age for the particular inventory item satisfies the turnover age threshold, the views threshold may be determined not based on the age for the particular inventory item, such as by:

$${T}_{views} = {v}_{expected} + {S}_{fame} . \qquad ( 3 )$$

In one example, the fame score, S_{fame}, can be determined by:

$${S}_{fame} = {S}_{make} + {S}_{model} \qquad ( 4 )$$

where Sₘₐₖₑ represents the make fame score and S_{model} represents the model fame score. The make fame score, S_{fame}, can be obtained by:

$${S}_{make} = w ( make ) * {s}_{make - fame} \qquad ( 5 )$$

where w(make) represents a make fame weight that can be determined based on a make label (make) associated with the particular inventory item. For instance, the make label may be used in conjunction with a lookup table or other data structure to identify a make fame weight corresponding to the make label. Makes associated with higher fame can correspond to relatively higher make fame weights, whereas makes associated with lower fame can correspond to relatively lower make fame weights (e.g., make fame weights being within a range of −50 to 50, or another range of values). s_{make-fame} represents a make fame scaler (e.g., within a range of 0.1 to 0.4, or another range of values). The model fame score, S_{model}, can be obtained by:

$${S}_{model} = w ( model ) + {s}_{model - fame} \qquad ( 6 )$$

where w(model) represents a model fame weight that can be determined based on a model label (model) associated with the particular inventory item. For instance, the model label may be used in conjunction with a lookup table or other data structure to identify a model fame weight corresponding to the model label. Models associated with higher fame can correspond to relatively higher model fame weights, whereas models associated with lower fame can correspond to relatively lower model fame weights (e.g., model fame weights being within a range of −50 to 50, or another range of values). s_{model-fame} represents a make fame scaler (e.g., within a range of 0.2 to 0.8, or another range of values).

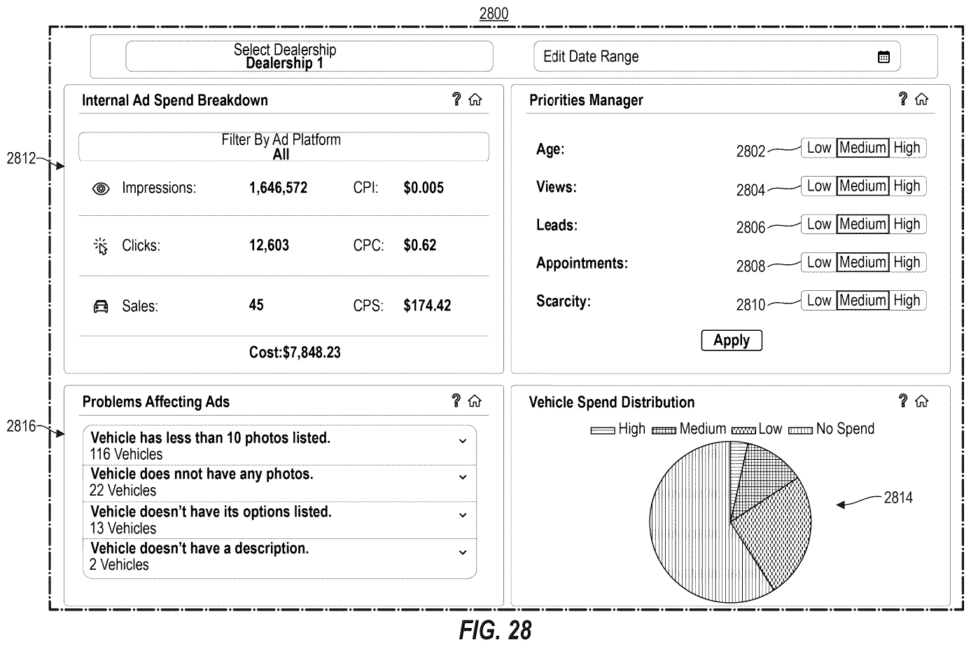

The views threshold (e.g., T_{views}) may be used in conjunction with a views metric for the particular inventory item to determine the views evaluation score delta. The views metric can indicate the quantity of viewings of the particular inventory item. In some implementations, the views evaluation score delta is determined based on whether the views metric satisfies the views threshold. In one example, if the views metric fails to satisfy the views threshold, the views evaluation score delta can be determined as a weighted ratio of the views threshold to the views metric, such as by:

$${Δ}_{views} = \frac{{T}_{views}}{v} {w}_{views} \qquad ( 7 )$$

where Δ_{views} represents the views evaluation score delta, v represents the views metric, and w_{views} represents a views weight. In some implementations, a floor is imposed on the views metric (e.g., within a range of 5 to 20, or another range of values, which can contribute to avoidance of divide by zero errors). The views weight can be based on the default views weight (e.g., w_{views-default}) and/or a user-defined views weight. For instance, a user interface frontend (e.g., see FIG. 28) may be configured to facilitate user designation of a modification to the default views weight (e.g., by doubling, halving, or another modification), which may be implemented to define the views evaluation score delta. In some implementations, user-driven modifications to the views weight do not affect the determination of the views threshold. Continuing with the foregoing example, if the views metric satisfies the views threshold, the views evaluation score delta can be determined as a negative weighted ratio of the views metric to the views threshold, such as by:

$${Δ}_{views} = - \frac{v}{{T}_{views}} {w}_{views} . \qquad ( 8 )$$

A leads evaluation score delta may be determined by using the age for the particular inventory item to determine a leads threshold. The leads threshold can represent a quantity of leads that the particular inventory item is expected or desired to have based on its age. The leads threshold can additionally or alternatively be based on other metrics, data, or information associated with the particular inventory item, such as an expected leads metric. The expected leads metric can indicate a quantity of leads that the particular inventory item is expected or desired to have over the turnover age threshold. The expected leads metric can be tailored to different implementations (e.g., within a range of 5 to 25).

In some implementations, the leads threshold is determined based on whether the age for the particular inventory item satisfies the turnover age threshold. In one example, if the age for the particular inventory item fails to satisfy the turnover age threshold, the leads threshold may be determined based on a function of the age for the particular inventory item (e.g., a polynomial function of age), such as by:

$${T}_{leads} = - ( \frac{( a - {a}_{turnover} ) ( a - {a}_{turnover} )}{Const} ) + {l}_{expected} \qquad ( 9 )$$

where T_{leads} represents the leads threshold, a represents the age for the particular inventory item, aₜᵤᵣₙₒᵥₑᵣ represents the turnover age threshold, Const represents a constant (e.g., a product of a default leads weight and the turnover age threshold, or a value within a range of 45 to 180 or another range of values), l_{expected} represents the expected leads metric. Continuing with the foregoing example, if the age for the particular inventory item satisfies the turnover age threshold, the leads threshold may be determined not based on the age for the particular inventory item, such as by:

$${T}_{leads} = {l}_{expected} . \qquad ( 10 )$$

The leads threshold (e.g., T_{leads}) may be used in conjunction with a leads metric for the particular inventory item to determine the leads evaluation score delta. The leads metric can indicate a quantity of leads obtained for the particular inventory item. In some implementations, the leads evaluation score delta is determined based on whether the leads metric satisfies the leads threshold. In one example, if the leads metric fails to satisfy the leads threshold, the leads evaluation score delta can be determined as a weighted ratio of the leads threshold to the leads metric, such as by:

$${Δ}_{leads} = \frac{{T}_{leads}}{l} {w}_{leads} \qquad ( 11 )$$

where Δ_{leads} represents the leads evaluation score delta, l represents the leads metric, and w_{views} represents a leads weight. In some implementations, a floor is imposed on the leads metric (e.g., within a range of 1 to 10, or another range of values, which can contribute to avoidance of divide by zero errors). The leads weight can be based on a default leads weight (e.g., within a range of 1 to 6, or another range of values) and/or a user-defined leads weight. For instance, a user interface frontend (e.g., see FIG. 28) may be configured to facilitate user designation of a modification to the default leads weight, which may be implemented to define the leads evaluation score delta. In some implementations, user-driven modifications to the leads weight do not affect the determination of the leads threshold. Continuing with the foregoing example, if the leads metric satisfies the leads threshold, the leads evaluation score delta can be determined as a negative weighted ratio of the leads metric to the leads threshold, such as by:

$${Δ}_{leads} = - \frac{l}{{T}_{leads}} {w}_{leads} . \qquad ( 12 )$$

An appointments evaluation score delta may be determined based on an appointments threshold and an appointments metric for the particular inventory item. The appointments metric can indicate a quantity of appointments obtained (e.g., set or completed) for the particular inventory item. In some implementations, the appointments threshold represents a quantity of appointments expected or desired to be made in association with the particular inventory item within a period of time (e.g., within the turnover age threshold, within the age effectiveness threshold, etc.). The appointments threshold may be tailored to different implementations (e.g., within a range of 1 to 5, or within another range of values).

In some implementations, the appointments evaluation score delta is determined based on whether the appointments metric satisfies the appointments threshold. In one example, if the appointments metric fails to satisfy the appointments threshold, the appointments evaluation score delta may be determined as the appointments weight, such as by:

$${Δ}_{appointments} = {w}_{appointments} \qquad ( 13 )$$

where Δₐₚₚₒᵢₙₜₘₑₙₜₛ represents the appointments evaluation score delta and wₐₚₚₒᵢₙₜₘₑₙₜₛ represents an appointments weight, which can be based on a default appointments weight (e.g., within a range of 5 to 20, or another range of values) and/or a user-defined appointments weight. For instance, a user interface frontend (e.g., see FIG. 28) may be configured to facilitate user designation of a modification to the default appointments weight, which may be implemented to define the appointments evaluation score delta. Continuing with the foregoing example, if the appointments metric satisfies the appointments threshold, the appointments evaluation score delta can be determined as a negative appointments weight, such as by:

$${Δ}_{appointments} = - {w}_{appointments} . \qquad ( 14 )$$

In some implementations, the appointments evaluation score delta may be further modified based on the age for the particular inventory item. For instance, if the age for the particular inventory item fails to satisfy the turnover age threshold, the appointments evaluation score delta may be selectively reduced (e.g., by half, or another ratio), which may mitigate outsized influence of the appointments evaluation score delta on the evaluation score for the particular inventory item.

A color evaluation score delta may be determined based on a color weight and a color label associated with the particular inventory item, such as by:

$${Δ}_{color} = - δ ( color ) * {w}_{color} \qquad ( 15 )$$

where Δ_{color} represents the color evaluation score delta, δ(color) represents an initial color evaluation score delta, and w_{color} represents the color weight. The initial color evaluation score delta may be determined based on a color label (color) associated with the particular inventory item. For instance, the color label may be used in conjunction with a lookup table or other data structure to identify an initial color evaluation score delta corresponding to the color label. Color labels associated with more frequently purchased colors can correspond to higher initial color evaluation score deltas, whereas color labels associated with less frequently purchased colors can correspond to lower initial color evaluation score deltas. An example ordering of color labels (beginning with color labels associated with higher initial color evaluation score deltas) can include: black, white, gray/grey, silver, blue, red, brown, gold, green, tan, orange, purple, yellow, and other (e.g., with corresponding initial color evaluation score deltas being within a range of 0 to 60, or another range of values). The color weight can be based on a default color weight (e.g., within a range of 0.1 to 0.6, or another range of values) and/or a user-defined color weight.

A make evaluation score delta may be determined based on a make weight and a make label associated with the particular inventory item, such as by:

$${Δ}_{make} = δ ( make ) * {w}_{make} \qquad ( 16 )$$

where Δₘₐₖₑ represents the make evaluation score delta, δ(make) represents an initial make evaluation score delta, and wₘₐₖₑ represents the make weight. The initial make evaluation score delta may be determined based on a make label (make) associated with the particular inventory item. For instance, the make label may be used in conjunction with a lookup table or other data structure to identify an initial make evaluation score delta corresponding to the make label. Make labels associated with more famous makes can correspond to lower initial make evaluation score deltas, whereas make labels associated with less famous makes can correspond to higher initial make evaluation score deltas (e.g., with initial make evaluation score deltas being within a range of −60 to 60, or within another range of values). The make weight can be based on a default make weight (e.g., within a range of 0.2 to 0.8, or another range of values) and/or a user-defined make weight.

A model evaluation score delta may be determined based on a model weight and a model label associated with the particular inventory item, such as by:

$${Δ}_{model} = δ ( model ) * {w}_{model} \qquad ( 17 )$$

where Δ_{model} represents the model evaluation score delta, δ(model) represents an initial model evaluation score delta, and w_{model} represents the model weight. The initial model evaluation score delta may be determined based on a model label (model) associated with the particular inventory item. For instance, the model label may be used in conjunction with a lookup table or other data structure to identify an initial model evaluation score delta corresponding to the model label. Model labels associated with more famous models can correspond to lower initial model evaluation score deltas, whereas model labels associated with less famous models can correspond to higher initial model evaluation score deltas (e.g., with initial model evaluation score deltas being within a range of −40 to 40, or within another range of values). The model weight can be based on a default model weight (e.g., within a range of 0.2 to 0.8, or another range of values) and/or a user-defined model weight.

A condition evaluation score delta may be determined based on a condition weight and a condition label associated with the particular inventory item, such as by:

$${Δ}_{condition} = δ ( condition ) * {w}_{condition} \qquad ( 18 )$$

where Δ_{condition} represents the condition evaluation score delta, δ(condition) represents an initial condition evaluation score delta, and w_{condition} represents the condition weight. The initial condition evaluation score delta may be determined based on a condition label (condition) associated with the particular inventory item. For instance, the condition label may be used in conjunction with a lookup table or other data structure to identify an initial condition evaluation score delta corresponding to the condition label. By way of illustrative example, a “new” condition label may correspond to a first initial condition evaluation score delta (e.g., within a range of 5 to 20, or another range of values), a “used” condition label may correspond to a second initial condition evaluation score delta (e.g., within a range of −5 to 5, or another range of values), and a “certified” or “certified used” condition label may correspond to a third initial condition evaluation score delta (e.g., within a range of −10 to 0, or another range of values). The condition weight can be based on a default condition weight (e.g., within a range of 0.5 to 2, or another range of values) and/or a user-defined condition weight.

A scarcity evaluation score delta may be determined based on the make label, the model label, and the year label associated with the particular inventory item. For instance, local scarcity and national scarcity for the particular inventory item may be determined using the make label, the model label, and the year label (e.g., using a vehicle sales scarcity database). National and local scarcity can indicate VDP views per listing for a given vehicle specification (e.g., make, model, year) for a specific geographic region (e.g., whether local or national). The national and local scarcity for the particular inventory item may be used in conjunction with average national and local scarcity, respectively, to determine the scarcity evaluation score delta.

By way of illustrative example, the scarcity evaluation score delta may be determined via:

$${Δ}_{scarcity} = {Δ}_{local} + {Δ}_{national} \qquad ( 19 )$$

where Δ_{scarcity} represents the scarcity evaluation score delta, Δ_{local} represents a local scarcity evaluation score delta, and Δₙₐₜᵢₒₙₐₗ represents a national scarcity evaluation score delta. In some instances, the local scarcity evaluation score delta is determined based on whether the local scarcity for the particular inventory item is less than average local scarcity (e.g., average local VDP views). In one example, if the local scarcity is less than the average local scarcity, the scarcity evaluation score delta, Δ_{scarcity}, may be determined via:

$${Δ}_{local} = \frac{{σ}_{local}}{{σ}_{average - local}} {w}_{scarcity} * Const \qquad ( 20 )$$

where σ_{local} represents the local scarcity for the particular inventory item, average-local represents the average local scarcity, w_{scarcity} represents a scarcity weight, and Const represents a constant (e.g., 2, or another value). The scarcity weight can be based on a default scarcity weight (e.g., within a range of 5 to 30, or another range of values) and/or a user-defined scarcity weight. For instance, a user interface frontend (e.g., see FIG. 28) may be configured to facilitate user designation of a modification to the default scarcity weight, which may be implemented to define the scarcity evaluation score delta. Continuing with the foregoing example, if the local scarcity is equal to or greater than (or only greater than) the average local scarcity, the scarcity evaluation score delta, Δ_{scarcity}, may be determined via:

$${Δ}_{local} = - \frac{{σ}_{local}}{{σ}_{average - local}} {w}_{scarcity} * Const . \qquad ( 21 )$$

In some instances, the national scarcity evaluation score delta is determined based on whether the national scarcity for the particular inventory item is less than average national scarcity (e.g., average national VDP views). In one example, if the national scarcity is less than the average national scarcity, the scarcity evaluation score delta, Δ_{scarcity}, may be determined via:

$${Δ}_{national} = \frac{{σ}_{national}}{{σ}_{average - national}} {w}_{scarcity} * Const \qquad ( 22 )$$

where σ_{local} represents the national scarcity for the particular inventory item, σ_{average-local} represents the average national scarcity, w_{scarcity} represents a scarcity weight, and Const represents a constant (e.g., 2, or another value). The scarcity weight can be based on a default scarcity weight (e.g., within a range of 5 to 30, or another range of values) and/or a user-defined scarcity weight. For instance, a user interface frontend (e.g., see FIG. 28) may be configured to facilitate user designation of a modification to the default scarcity weight, which may be implemented to define the scarcity evaluation score delta. Continuing with the foregoing example, if the national scarcity is equal to or greater than (or only greater than) the average national scarcity, the scarcity evaluation score delta, Δ_{scarcity}, may be determined via:

$${Δ}_{national} = - \frac{{σ}_{national}}{{σ}_{average - national}} {w}_{scarcity} * Const . \qquad ( 23 )$$

Act 2504 of flow diagram 2500 includes determining an evaluation score for the particular inventory item using the plurality of evaluation score deltas. In some implementations, determining the evaluation score for the particular inventory item comprises modifying an initial evaluation score with the plurality of evaluation score deltas (or aggregating the initial evaluation score with the plurality of evaluation score deltas). The initial evaluation score may be tailored to different implementations (e.g., within a range of 50 to 200, or within another range of values). As an illustrative example, the evaluation score may be determined via:

$$E = {E}_{initial} + {Δ}_{age} + {Δ}_{views} + {Δ}_{leads} + {Δ}_{appointments} + {Δ}_{color} + {Δ}_{make} + {Δ}_{model} + {Δ}_{condition} + {Δ}_{scarcity} \qquad ( 24 )$$

where E represents the evaluation score and Eᵢₙᵢₜᵢₐₗ represents the initial evaluation score.

Act 2506 of flow diagram 2500 includes determining an inventory resource allocation level for the particular inventory item based on the evaluation score. In some implementations, the inventory resource allocation level is selected from a plurality or set of predefined inventory resource allocation levels. In one example, the set of predefined inventory resource allocation levels includes a no spend category, a low spend category, a medium spend category, and a high spend category (other allocation levels are within the scope of the present disclosure). Each of the inventory resource allocation levels can be associated with a respective evaluation score range, such that each inventory item in a set of inventory items may be sorted into the different inventory resource allocation levels based on its corresponding evaluation score. Continuing with the foregoing example, inventory items with an evaluation score of less than 60-200 (or another value) can be assigned to the no spend category, inventory items with an evaluation score within a range of about 60 to 270 (or another range) can be assigned to the low spend category, inventory items with an evaluation score within a range of 100 to 320 (or another range) can be assigned to the medium spend category, and inventory items with an evaluation score equal to or exceeding 180-320 (or another value) can be assigned to the high spend category.

Act 2508 of flow diagram 2500 includes causing presentation of a user interface frontend that displays the inventory resource allocation level determined for each particular inventory item of the set of inventory items. Example user interface frontends that display the inventory resource allocation level for individual inventory items include the VIN dashboard 1800 (e.g., showing spend categories 1834), the advertisement channel breakdown 2300 (e.g., advertisement channels 2302), and the advertisement dashboard 2400 (e.g., showing spend levels 2422).

Act 2510 of flow diagram 2500 includes causing presentation of a user interface frontend that displays, for each particular inventory resource allocation level of the plurality of inventory resource allocation levels, a quantity of inventory items from the set of inventory items for which the particular inventory resource allocation level was determined. The user interface frontend may display a representation of each different inventory resource allocation level and a corresponding quantity of inventory items assigned or sorted into each inventory resource allocation level. In some implementations, the user interface frontend is configured to (i) facilitate selective activation or deactivation of automated resource allocation associated with each inventory resource allocation level of the plurality of inventory resource allocation levels and/or (ii) facilitate selective modification of a per-item resource allocation amount associated with each inventory resource allocation level of the plurality of inventory resource allocation levels.

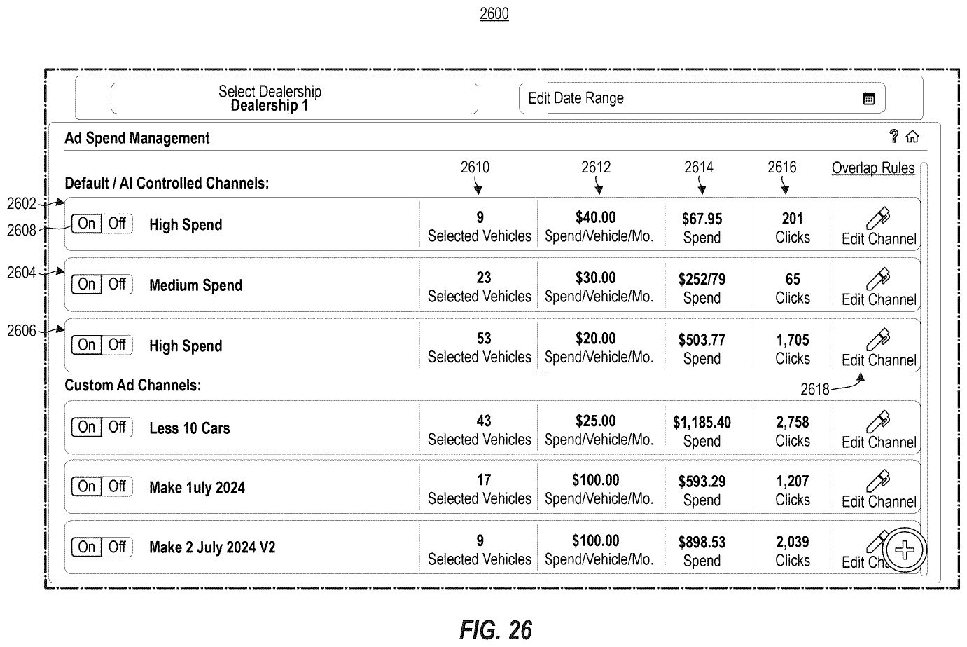

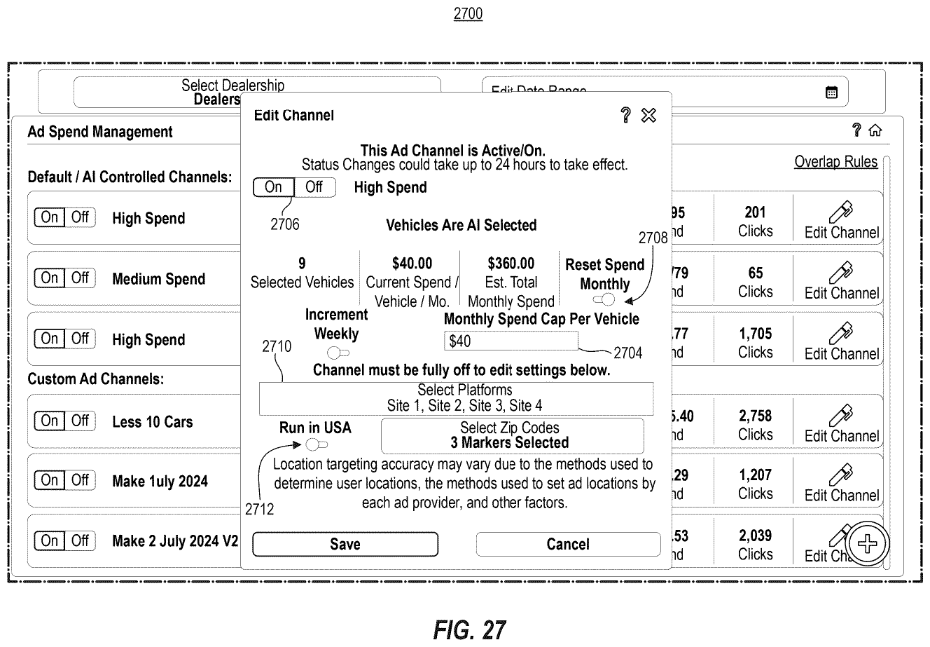

FIG. 26 illustrates an example user interface frontend implemented as an advertisement spending management tool 2600. In the example shown in FIG. 26, the advertisement spending management tool 2600 includes a representation of different inventory resource allocation levels, including high spend category 2602, medium spend category 2604, and low spend category 2606. Each inventory resource allocation level includes an activate/deactivate control 2608, which can facilitate selective activation or deactivation of automated resource allocation (e.g., advertisement spending) for the individual inventory resource allocation levels (e.g., spend categories). The spending management tool 2600 also displays, for each inventory resource allocation level, the quantity 2610 of vehicles assigned to the inventory resource allocation level, an amount of spending per item per month 2612 (or other time period), a total spend amount 2614 (e.g., across multiple vehicles per month or other time period), clicks 2616, and an edit control 2618. FIG. 27 illustrates an edit channel interface 2700, which may be displayed after selection of an edit control 2618 associated with one of the inventory resource allocation levels represented in the advertisement spending management tool 2600. In the example shown in FIG. 27, the edit channel interface 2700 is associated with the high spend category 2602. The edit channel interface 2700 comprises a user interface frontend that enables modification (e.g., via field 2704) of per-item resource allocation amount for inventory items assigned to the high spend category 2602. The edit channel interface 2700 also includes an activate/deactivate control 2706 for the high spend category 2602, as well as an indication of the quantity vehicles included in the high spend category 2602 and the estimated total monthly spending for the high spend category 2602. The edit channel interface 2700 shown in FIG. 27 further includes a control 2708 for automatically resetting or re-allocating resource allocation each month (or other time period), a control 2710 for selecting the promotional communications platforms (e.g., advertising platforms) on which to spend the resources allocated in accordance with the high spend category 2602, and controls 2712 for defining the geographic regions in which to target the promotional communications associated with the selected platforms for the high spend category 2602.

Referring again to FIG. 25, act 2512 of flow diagram 2500 includes automatically updating resource allocation settings for the particular inventory item on one or more promotional communications platforms based on the inventory resource allocation level for the particular inventory item. For a given inventory resource allocation level, the promotional communications platforms for which resource allocation settings become updated can comprise platforms indicated on a user interface frontend (e.g., the platforms indicated at the edit channel interface 2700 for the high spend category 2602.

FIG. 28 illustrates an example user interface frontend 2800 that provides controls for modifying various weights described hereinabove for determining evaluation score deltas associated with different inventory item dimensions. For instance, the user interface frontend 2800 shown in FIG. 28 includes a priorities manager section that includes an age weight control 2802, a views weight control 2804, a leads weight control 2806, an appointments weight control 2808, and a scarcity weight control 2810. Although the weight controls shown in FIG. 28 comprises selectable elements associated with different weight levels (e.g., low, medium, high), other weight control frameworks are within the scope of the present disclosure, (e.g., a sliding scale, an entry field, a dropdown menu, etc.).

The user interface frontend 2800 further includes an internal advertisement spend breakdown section 2812 that indicates various internal advertising metrics, such as impressions, clicks, sales, CPI (cost per impression), CPC (cost per click), and CPS (cost per sale). The user interface frontend 2800 further includes a vehicle spend distribution section 2814 providing a graphical representation of the distribution of vehicles among the various spend categories (or inventory resource allocation levels). The user interface frontend 2800 shown in FIG. 28 further includes a problems section 2816 where problems determined to be present in one or more advertisements are communicated to users to facilitate corrective action.

Embodiments of the disclosed subject matter can include at least those in the following numbered clauses:

Clause 1. A system for controlling inventory-specific resource allocation, the system comprising: one or more processors; and one or more computer-readable recording media that store instructions that are executable by the one or more processors to configure the system to: for each particular inventory item of a set of inventory items: determine a plurality of evaluation score deltas, each of the plurality of evaluation score deltas being associated with a respective inventory dimension of a plurality of inventory dimensions associated with the particular inventory item, the plurality of inventory dimensions comprising at least views and age, wherein determining the plurality of evaluation score deltas comprises: determining an age for the particular inventory item; determining whether the age for the particular inventory item satisfies a turnover age threshold; if the age for the particular inventory item fails to satisfy the turnover age threshold, determining a views threshold for the particular inventory item based on a function of the age for the particular inventory item; if the age of the particular inventory item satisfies the turnover age threshold, determining the views threshold for the particular inventory item not based on the function of the age for the particular inventory item; accessing a views metric for the particular inventory item; if the views metric fails to satisfy the views threshold, defining a views evaluation score delta for the plurality of evaluation score deltas as a weighted ratio of the views threshold to the views metric; and if the views metric satisfies the views threshold, defining the views evaluation score delta for the plurality of evaluation score deltas as a negative weighted ratio of the views metric to the views threshold; determine an evaluation score for the particular inventory item using the plurality of evaluation score deltas; determine an inventory resource allocation level for the particular inventory item based on the evaluation score; and automatically update resource allocation settings for the particular inventory item on one or more promotional communications platforms based on the inventory resource allocation level for the particular inventory item.

Clause 2. The system of clause 1, wherein the views threshold is based on an expected views metric.

Clause 3. The system of clause 2, wherein the views threshold is based on a fame score associated with the particular inventory item.

Clause 4. The system of clause 1, wherein a views weight for determining the views evaluation score delta is based on a default views weight and/or a user-defined views weight.

Clause 5. The system of clause 1, wherein determining the plurality of evaluation score deltas further comprises: defining an age evaluation score delta for the plurality of evaluation score deltas based on the age for the particular inventory item and an age weight, wherein the age weight is selected based on the age for the particular inventory item.

Clause 6. The system of clause 1, wherein the plurality of inventory dimensions further comprises one or more of leads, appointments, color, make, model, condition, or scarcity.

Clause 7. The system of clause 6, wherein determining the plurality of evaluation score deltas further comprises: if the age of the particular inventory item fails to satisfy the turnover age threshold, determining a leads threshold for the particular inventory item based on a function of the age for the particular inventory item and an expected leads metric; if the age of the particular inventory item satisfies the turnover age threshold, determining the leads threshold for the particular inventory item based on the expected leads metric and not based on the function of the age for the particular inventory item; accessing a leads metric for the particular inventory item; if the leads metric fails to satisfy the leads threshold, defining a leads evaluation score delta for the plurality of evaluation score deltas as a weighted ratio of the leads threshold to the leads metric; and if the leads metric satisfies the leads threshold, defining the leads evaluation score delta for the plurality of evaluation score deltas as a negative weighted ratio of the leads metric to the leads threshold, wherein a leads weight for determining the leads evaluation score delta is based on a default leads weight and/or a user-defined leads weight.

Clause 8. The system of clause 6, wherein determining the plurality of evaluation score deltas further comprises: accessing an appointments metric for the particular inventory item; if the appointments metric fails to satisfy an appointments threshold, defining an appointments evaluation score delta for the plurality of evaluation score deltas as an appointments weight, wherein the appointments weight is based on a default appointments weight and/or a user-defined appointments weight; if the appointments metric satisfies the appointments threshold, defining the appointments evaluation score delta for the plurality of evaluation score deltas as a negative appointments weight; and if the age of the particular inventory item fails to satisfy the turnover age threshold, reducing the appointments evaluation score delta.

Clause 9. The system of clause 6, wherein determining the plurality of evaluation score deltas further comprises: accessing a color label for the particular inventory item; and defining a color evaluation score delta for the plurality of evaluation score deltas based on the color label and a color weight, wherein the color weight is based on a default color weight and/or a user-defined color weight.

Clause 10. The system of clause 6, wherein determining the plurality of evaluation score deltas further comprises: accessing a make label for the particular inventory item; and defining a make evaluation score delta for the plurality of evaluation score deltas based on the make label and a make weight, wherein the make weight is based on a default make weight and/or a user-defined make weight.

Clause 11. The system of clause 6, wherein determining the plurality of evaluation score deltas further comprises: accessing a model label for the particular inventory item; and defining a model evaluation score delta for the plurality of evaluation score deltas based on the model label and a model weight, wherein the model weight is based on a default model weight and/or a user-defined model weight.

Clause 12. The system of clause 6, wherein determining the plurality of evaluation score deltas further comprises: accessing a condition label for the particular inventory item; and defining a condition evaluation score delta for the plurality of evaluation score deltas based on the condition label and a condition weight, wherein the condition weight is based on a default condition weight and/or a user-defined condition weight.

Clause 13. The system of clause 6, wherein determining the plurality of evaluation score deltas further comprises: accessing a make label, a model label, and a year label for the particular inventory item; determining a local scarcity and a national scarcity for the particular inventory item based on the make label, the model label, and the year label; if the local scarcity is less than an average local scarcity, defining a scarcity evaluation score delta for the plurality of evaluation score deltas as a weighted ratio of the local scarcity to the average local scarcity; if the local scarcity is greater than or equal to the average local scarcity, defining the scarcity evaluation score delta for the plurality of evaluation score deltas as a negative weighted ratio of the local scarcity to the average local scarcity; if the national scarcity is less than an average national scarcity, modifying the scarcity evaluation score delta by adding a weighted ratio of the national scarcity to the average national scarcity; and if the national scarcity is greater than or equal to the average national scarcity, modifying the scarcity evaluation score delta by subtracting a weighted ratio of the national scarcity to the average national scarcity, wherein a scarcity weight for determining the scarcity evaluation score delta is based on a default scarcity weight and/or a user-defined scarcity weight.

Clause 14. The system of clause 1, wherein determining the evaluation score for the particular inventory item comprises modifying an initial evaluation score with the plurality of evaluation score deltas.

Clause 15. The system of clause 1, wherein the inventory resource allocation level is selected from a plurality of inventory resource allocation levels.

Clause 16. The system of clause 15, wherein the instructions are executable by the one or more processors to configure the system to: cause presentation of a user interface frontend that displays, for each particular inventory resource allocation level of the plurality of inventory resource allocation levels, a quantity of inventory items from the set of inventory items for which the particular inventory resource allocation level was determined.

Clause 17. The system of clause 16, wherein the user interface frontend is configured to (i) facilitate selective activation or deactivation of automated resource allocation associated with each inventory resource allocation level of the plurality of inventory resource allocation levels and/or (ii) facilitate selective modification of a per-item resource allocation amount associated with each inventory resource allocation level of the plurality of inventory resource allocation levels.

Clause 18. The system of clause 15, the instructions are executable by the one or more processors to configure the system to: cause presentation of a user interface frontend that displays the inventory resource allocation level determined for each particular inventory item of the set of inventory items.

Clause 19. A method for controlling inventory-specific resource allocation, the method comprising: for each particular inventory item of a set of inventory items: determining a plurality of evaluation score deltas, each of the plurality of evaluation score deltas being associated with a respective inventory dimension of a plurality of inventory dimensions associated with the particular inventory item, the plurality of inventory dimensions comprising at least views and age, wherein determining the plurality of evaluation score deltas comprises: determining an age for the particular inventory item; determining whether the age for the particular inventory item satisfies a turnover age threshold; if the age for the particular inventory item fails to satisfy the turnover age threshold, determining a views threshold for the particular inventory item based on a function of the age for the particular inventory item; if the age of the particular inventory item satisfies the turnover age threshold, determining the views threshold for the particular inventory item not based on the function of the age for the particular inventory item; accessing a views metric for the particular inventory item; if the views metric fails to satisfy the views threshold, defining a views evaluation score delta for the plurality of evaluation score deltas as a weighted ratio of the views threshold to the views metric; and if the views metric satisfies the views threshold, defining the views evaluation score delta for the plurality of evaluation score deltas as a negative weighted ratio of the views metric to the views threshold; determining an evaluation score for the particular inventory item using the plurality of evaluation score deltas; determining an inventory resource allocation level for the particular inventory item based on the evaluation score; and automatically updating resource allocation settings for the particular inventory item on one or more promotional communications platforms based on the inventory resource allocation level for the particular inventory item.

Clause 20. The method of clause 19, wherein the views threshold is based on an expected views metric.

Clause 21. The method of clause 20, wherein the views threshold is based on a fame score associated with the particular inventory item.

Clause 22. The method of clause 19, wherein a views weight for determining the views evaluation score delta is based on a default views weight and/or a user-defined views weight.

Clause 23. The method of clause 19, wherein determining the plurality of evaluation score deltas further comprises: defining an age evaluation score delta for the plurality of evaluation score deltas based on the age for the particular inventory item and an age weight, wherein the age weight is selected based on the age for the particular inventory item.

Clause 24. The method of clause 19, wherein the plurality of inventory dimensions further comprises one or more of leads, appointments, color, make, model, condition, or scarcity.

Clause 25. The method of clause 24, wherein determining the plurality of evaluation score deltas further comprises: if the age of the particular inventory item fails to satisfy the turnover age threshold, determining a leads threshold for the particular inventory item based on a function of the age for the particular inventory item and an expected leads metric; if the age of the particular inventory item satisfies the turnover age threshold, determining the leads threshold for the particular inventory item based on the expected leads metric and not based on the function of the age for the particular inventory item; accessing a leads metric for the particular inventory item; if the leads metric fails to satisfy the leads threshold, defining a leads evaluation score delta for the plurality of evaluation score deltas as a weighted ratio of the leads threshold to the leads metric; and if the leads metric satisfies the leads threshold, defining the leads evaluation score delta for the plurality of evaluation score deltas as a negative weighted ratio of the leads metric to the leads threshold, wherein a leads weight for determining the leads evaluation score delta is based on a default leads weight and/or a user-defined leads weight.

Clause 26. The method of clause 24, wherein determining the plurality of evaluation score deltas further comprises: accessing an appointments metric for the particular inventory item; if the appointments metric fails to satisfy an appointments threshold, defining an appointments evaluation score delta for the plurality of evaluation score deltas as an appointments weight, wherein the appointments weight is based on a default appointments weight and/or a user-defined appointments weight; if the appointments metric satisfies the appointments threshold, defining the appointments evaluation score delta for the plurality of evaluation score deltas as a negative appointments weight; and if the age of the particular inventory item fails to satisfy the turnover age threshold, reducing the appointments evaluation score delta.

Clause 27. The method of clause 24, wherein determining the plurality of evaluation score deltas further comprises: accessing a color label for the particular inventory item; and defining a color evaluation score delta for the plurality of evaluation score deltas based on the color label and a color weight, wherein the color weight is based on a default color weight and/or a user-defined color weight.

Clause 28. The method of clause 24, wherein determining the plurality of evaluation score deltas further comprises: accessing a make label for the particular inventory item; and defining a make evaluation score delta for the plurality of evaluation score deltas based on the make label and a make weight, wherein the make weight is based on a default make weight and/or a user-defined make weight.

Clause 29. The method of clause 24, wherein determining the plurality of evaluation score deltas further comprises: accessing a model label for the particular inventory item; and defining a model evaluation score delta for the plurality of evaluation score deltas based on the model label and a model weight, wherein the model weight is based on a default model weight and/or a user-defined model weight.

Clause 30. The method of clause 24, wherein determining the plurality of evaluation score deltas further comprises: accessing a condition label for the particular inventory item; and defining a condition evaluation score delta for the plurality of evaluation score deltas based on the condition label and a condition weight, wherein the condition weight is based on a default condition weight and/or a user-defined condition weight.

Clause 31. The method of clause 24, wherein determining the plurality of evaluation score deltas further comprises: accessing a make label, a model label, and a year label for the particular inventory item; determining a local scarcity and a national scarcity for the particular inventory item based on the make label, the model label, and the year label; if the local scarcity is less than an average local scarcity, defining a scarcity evaluation score delta for the plurality of evaluation score deltas as a weighted ratio of the local scarcity to the average local scarcity; if the local scarcity is greater than or equal to the average local scarcity, defining the scarcity evaluation score delta for the plurality of evaluation score deltas as a negative weighted ratio of the local scarcity to the average local scarcity; if the national scarcity is less than an average national scarcity, modifying the scarcity evaluation score delta by adding a weighted ratio of the national scarcity to the average national scarcity; and if the national scarcity is greater than or equal to the average national scarcity, modifying the scarcity evaluation score delta by subtracting a weighted ratio of the national scarcity to the average national scarcity, wherein a scarcity weight for determining the scarcity evaluation score delta is based on a default scarcity weight and/or a user-defined scarcity weight.

Clause 32. The method of clause 19, wherein determining the evaluation score for the particular inventory item comprises modifying an initial evaluation score with the plurality of evaluation score deltas.

Clause 33. The method of clause 19, wherein the inventory resource allocation level is selected from a plurality of inventory resource allocation levels.

Clause 34. The method of clause 33, further comprising: causing presentation of a user interface frontend that displays, for each particular inventory resource allocation level of the plurality of inventory resource allocation levels, a quantity of inventory items from the set of inventory items for which the particular inventory resource allocation level was determined.

Clause 35. The method of clause 34, wherein the user interface frontend is configured to (i) facilitate selective activation or deactivation of automated resource allocation associated with each inventory resource allocation level of the plurality of inventory resource allocation levels and/or (ii) facilitate selective modification of a per-item resource allocation amount associated with each inventory resource allocation level of the plurality of inventory resource allocation levels.

Clause 36. The method of clause 33, further comprising: cause presentation of a user interface frontend that displays the inventory resource allocation level determined for each particular inventory item of the set of inventory items.

Clause 37. One or more computer-readable recording media that store instructions that are executable by one or more processors of a system to configure the system to: for each particular inventory item of a set of inventory items: determine a plurality of evaluation score deltas, each of the plurality of evaluation score deltas being associated with a respective inventory dimension of a plurality of inventory dimensions associated with the particular inventory item, the plurality of inventory dimensions comprising at least views and age, wherein determining the plurality of evaluation score deltas comprises: determining an age for the particular inventory item; determining whether the age for the particular inventory item satisfies a turnover age threshold; if the age for the particular inventory item fails to satisfy the turnover age threshold, determining a views threshold for the particular inventory item based on a function of the age for the particular inventory item; if the age of the particular inventory item satisfies the turnover age threshold, determining the views threshold for the particular inventory item not based on the function of the age for the particular inventory item; accessing a views metric for the particular inventory item; if the views metric fails to satisfy the views threshold, defining a views evaluation score delta for the plurality of evaluation score deltas as a weighted ratio of the views threshold to the views metric; and if the views metric satisfies the views threshold, defining the views evaluation score delta for the plurality of evaluation score deltas as a negative weighted ratio of the views metric to the views threshold; determine an evaluation score for the particular inventory item using the plurality of evaluation score deltas; determine an inventory resource allocation level for the particular inventory item based on the evaluation score; and automatically update resource allocation settings for the particular inventory item on one or more promotional communications platforms based on the inventory resource allocation level for the particular inventory item.

Clause 38. The one or more computer-readable recording media of clause 37, wherein the views threshold is based on an expected views metric.

Clause 39. The one or more computer-readable recording media of clause 38, wherein the views threshold is based on a fame score associated with the particular inventory item.

Clause 40. The one or more computer-readable recording media of clause 37, wherein a views weight for determining the views evaluation score delta is based on a default views weight and/or a user-defined views weight.

Clause 41. The one or more computer-readable recording media of clause 37, wherein determining the plurality of evaluation score deltas further comprises: defining an age evaluation score delta for the plurality of evaluation score deltas based on the age for the particular inventory item and an age weight, wherein the age weight is selected based on the age for the particular inventory item.

Clause 42. The one or more computer-readable recording media of clause 37, wherein the plurality of inventory dimensions further comprises one or more of leads, appointments, color, make, model, condition, or scarcity.

Clause 43. The one or more computer-readable recording media of clause 42, wherein determining the plurality of evaluation score deltas further comprises: if the age of the particular inventory item fails to satisfy the turnover age threshold, determining a leads threshold for the particular inventory item based on a function of the age for the particular inventory item and an expected leads metric; if the age of the particular inventory item satisfies the turnover age threshold, determining the leads threshold for the particular inventory item based on the expected leads metric and not based on the function of the age for the particular inventory item; accessing a leads metric for the particular inventory item; if the leads metric fails to satisfy the leads threshold, defining a leads evaluation score delta for the plurality of evaluation score deltas as a weighted ratio of the leads threshold to the leads metric; and if the leads metric satisfies the leads threshold, defining the leads evaluation score delta for the plurality of evaluation score deltas as a negative weighted ratio of the leads metric to the leads threshold, wherein a leads weight for determining the leads evaluation score delta is based on a default leads weight and/or a user-defined leads weight.

Clause 44. The one or more computer-readable recording media of clause 42, wherein determining the plurality of evaluation score deltas further comprises: accessing an appointments metric for the particular inventory item; if the appointments metric fails to satisfy an appointments threshold, defining an appointments evaluation score delta for the plurality of evaluation score deltas as an appointments weight, wherein the appointments weight is based on a default appointments weight and/or a user-defined appointments weight; if the appointments metric satisfies the appointments threshold, defining the appointments evaluation score delta for the plurality of evaluation score deltas as a negative appointments weight; and if the age of the particular inventory item fails to satisfy the turnover age threshold, reducing the appointments evaluation score delta.

Clause 45. The one or more computer-readable recording media of clause 42, wherein determining the plurality of evaluation score deltas further comprises: accessing a color label for the particular inventory item; and defining a color evaluation score delta for the plurality of evaluation score deltas based on the color label and a color weight, wherein the color weight is based on a default color weight and/or a user-defined color weight.

Clause 46. The one or more computer-readable recording media of clause 42, wherein determining the plurality of evaluation score deltas further comprises: accessing a make label for the particular inventory item; and defining a make evaluation score delta for the plurality of evaluation score deltas based on the make label and a make weight, wherein the make weight is based on a default make weight and/or a user-defined make weight.

Clause 47. The one or more computer-readable recording media of clause 42, wherein determining the plurality of evaluation score deltas further comprises: accessing a model label for the particular inventory item; and defining a model evaluation score delta for the plurality of evaluation score deltas based on the model label and a model weight, wherein the model weight is based on a default model weight and/or a user-defined model weight.

Clause 48. The one or more computer-readable recording media of clause 42, wherein determining the plurality of evaluation score deltas further comprises: accessing a condition label for the particular inventory item; and defining a condition evaluation score delta for the plurality of evaluation score deltas based on the condition label and a condition weight, wherein the condition weight is based on a default condition weight and/or a user-defined condition weight.

Clause 49. The one or more computer-readable recording media of clause 42, wherein determining the plurality of evaluation score deltas further comprises: accessing a make label, a model label, and a year label for the particular inventory item; determining a local scarcity and a national scarcity for the particular inventory item based on the make label, the model label, and the year label; if the local scarcity is less than an average local scarcity, defining a scarcity evaluation score delta for the plurality of evaluation score deltas as a weighted ratio of the local scarcity to the average local scarcity; if the local scarcity is greater than or equal to the average local scarcity, defining the scarcity evaluation score delta for the plurality of evaluation score deltas as a negative weighted ratio of the local scarcity to the average local scarcity; if the national scarcity is less than an average national scarcity, modifying the scarcity evaluation score delta by adding a weighted ratio of the national scarcity to the average national scarcity; and if the national scarcity is greater than or equal to the average national scarcity, modifying the scarcity evaluation score delta by subtracting a weighted ratio of the national scarcity to the average national scarcity, wherein a scarcity weight for determining the scarcity evaluation score delta is based on a default scarcity weight and/or a user-defined scarcity weight.

Clause 50. The one or more computer-readable recording media of clause 37, wherein determining the evaluation score for the particular inventory item comprises modifying an initial evaluation score with the plurality of evaluation score deltas.

Clause 51. The one or more computer-readable recording media of clause 37, wherein the inventory resource allocation level is selected from a plurality of inventory resource allocation levels.

Clause 52. The one or more computer-readable recording media of clause 51, wherein the instructions are executable by the one or more processors to configure the system to: cause presentation of a user interface frontend that displays, for each particular inventory resource allocation level of the plurality of inventory resource allocation levels, a quantity of inventory items from the set of inventory items for which the particular inventory resource allocation level was determined.

Clause 53. The one or more computer-readable recording media of clause 52, wherein the user interface frontend is configured to (i) facilitate selective activation or deactivation of automated resource allocation associated with each inventory resource allocation level of the plurality of inventory resource allocation levels and/or (ii) facilitate selective modification of a per-item resource allocation amount associated with each inventory resource allocation level of the plurality of inventory resource allocation levels.

Clause 54. The one or more computer-readable recording media of clause 51, the instructions are executable by the one or more processors to configure the system to: cause presentation of a user interface frontend that displays the inventory resource allocation level determined for each particular inventory item of the set of inventory items.

### Additional Details Related to Implementing the Disclosed Embodiments

Disclosed embodiments may comprise or utilize a special-purpose or general-purpose computer including computer hardware, as discussed in greater detail below. Disclosed embodiments also include physical and other computer-readable recording media for carrying or storing computer-executable instructions and/or data structures. Such computer-readable recording media can be any available media that can be accessed by a general-purpose or special-purpose computer system. Computer-readable recording media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry program code in the form of computer-executable instructions or data structures, and which can be accessed by a general-purpose or special-purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may also be described in terms of various additional computer-specific examples for processing in a computer environment, particular examples that require the calculation speed and efficiency provided through a combination of processing in connection with complex learning, AI, or otherwise machine learning models (also referred to as machine learning algorithms) for use with the concepts and principles disclosed herein. For example, at least one implementation of the foregoing can be described in terms of a method of using an artificial intelligence or machine learning algorithm to identify patterns in large chucks of regional or global data to determine just-in-time resource allocations as follows. In such a case, a computer-implemented method of using an artificial neural network (ANN, machine learning, or artificial intelligence with language learning capability to detect a plurality of evaluation score deltas for use in determining a resource allocation can include the following:

### Training by a Computer to Develop a Trained Algorithm

As discussed above, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

The user of the present invention can thus train a machine learning algorithm executed by processor 102 to recognize a plurality of evaluation scores for various assets of particular types, and models taken from a plurality of different geographical locations over a specified duration. The user can further train the artificial intelligence with the processor 102 to determine an “evaluation score delta,” which weights the asset (e.g., vehicle) for various physical metrics, such as value of the asset, age of the asset, make, model and year of the asset, etc. The user can still further train the machine learning algorithm executed by processor 102 to “static initial evaluation score” and assign a corresponding value to the asset for resource allocation.

### Detecting Evaluation Score Deltas Using the Trained Algorithm

Using the trained algorithm executed by processor 102, the computer system can then detect “anomalies,” or “evaluation score deltas” among the among all of the data retrieved over multiple geographic locations, the data being received from one or more other computer systems over a network. For example, the computer system can take all of the accumulated data and evaluation scores for each asset, as further weighted on an asset by asset basis, and determine the extent to which any given asset meets a particular threshold, or is outside of the threshold. As noted above, an evaluation score delta may be obtained via the evaluation function (via processor 102) for each vehicle/asset dimension of each vehicle/asset. For each vehicle, the evaluation score deltas (for each dimension) and the static initial evaluation score may be aggregated (e.g., by summation). The aggregation result (e.g., a final evaluation score) may then be used by the computer system to assign each vehicle in a large set of vehicular data retrieved over the multiple locations, in real-time, to a spend category. For instance, the aggregation result may be compared to a set of score ranges, where each score range is associated with a respective spend category. The spend category associated with the score range in which the aggregation result falls may then be assigned by the computer system to the vehicle. Such a process may be performed by the executed computer intelligence in processor 102 for any set of vehicles at any desired cadence (e.g., daily, weekly, monthly, etc.), and can therefore be used to sort very large sets of vehicles into different spend categories and/or regularly update the spend categories for the set of vehicles in real-time for any particular geographic location. The real-time analytics section 300 can present vendor performance information for vendors associated with the store indicated by the store selector 202 and for the time period indicated by the time period selector 204.

### Detecting Evaluation Grades Relative to Thresholds Using the Computer System

The user can then deploy the computer system to generate an evaluation grade 1840 for a given inventory item based on an analysis of the age of the inventory item (e.g., whether the age meets or exceeds a turnover age or other age threshold), the views of the inventory item (e.g., whether the views accrued for the inventory item fails to satisfy a views threshold determined for the inventory item, as described in more detail hereinafter), the leads for the inventory item (e.g., whether the leads accrued for the inventory item fails to satisfy a leads threshold determined for the inventory item, as described in more detail hereinafter), the appointments for the inventory item (e.g., whether the appointments accrued for the inventory item fails to satisfy an appointments threshold determined for the inventory item, as described in more detail hereinafter), etc.

### Automatically Changing Asset and Resource Allocations in Real-Time

As noted above, the computer system can employ the artificial intelligence to automatically adjust (enhance, drop, etc.) resource allocations per asset across multiple geographic locations at the same time, thereby enabling just-in-time adaptations to industry or market changes. In other words, without the user of further user input, the computer system can intelligently identify misallocations of multiple resources in real-time based on various machine-determined weights applied to multiple assets in multiple locations at the same time, and then assign optimized allocations of resources on an asset-by-asset basis. For example, as discussed above with respect to act 2506 of diagram 2500, the computer system (via processor 102 and the executed machine intelligence thereon) can adjust an inventory resource allocation level for the particular inventory item based on the evaluation score. In some implementations, the inventory resource allocation level is selected by the machine learning algorithm from a plurality or set of predefined inventory resource allocation levels. In one example, the set of predefined inventory resource allocation levels includes a no spend category, a low spend category, a medium spend category, and a high spend category (other allocation levels are within the scope of the present disclosure). Each of the inventory resource allocation levels can be associated with a respective evaluation score range, such that each inventory item in a set of inventory items may be sorted into the different inventory resource allocation levels based on its corresponding evaluation score. Continuing with the foregoing example, inventory items with an evaluation score of less than 60-200 (or another value) can be assigned to the no spend category, the computer system can automatically assign inventory items with an evaluation score within a range of about 60 to 270 (or another range) to the low spend category, inventory items with an evaluation score within a range of 100 to 320 (or another range) to the medium spend category, and inventory items with an evaluation score equal to or exceeding 180-320 (or another value) to the high spend category.

### Real-Time Correction of Errant Allocations

The computer system can automatically adjust resource allocations in response to real-time data received from multiple locations in real, particularly validated real-time data, that the system has verified corrections. For example, as described with respect to FIG. 25, the computer system deploying the artificial intelligence and/or machine learning algorithm may automatically update resource allocation settings for the particular inventory item on one or more promotional communications platforms based on the inventory resource allocation level for the particular inventory item. For a given inventory resource allocation level, the promotional communications platforms for which resource allocation settings become updated can comprise platforms indicated on a user interface frontend (e.g., the platforms indicated at the edit channel interface 2700) for the high spend category 2602. In addition, the user interface frontend 2800 can provide personal interactive controls for modifying various weights described hereinabove for determining evaluation score deltas associated with different inventory item dimensions, which the computer system can then learn and employ for additional determinations of a particular asset or set/class of assets. For instance, the user interface frontend 2800 shown in FIG. 28 includes a priorities manager section that includes an age weight control 2802, a views weight control 2804, a leads weight control 2806, an appointments weight control 2808, and a scarcity weight control 2810. Although the weight controls shown in FIG. 28 comprises selectable elements associated with different weight levels (e.g., low, medium, high), other weight control frameworks are within the scope of the present disclosure, (e.g., a sliding scale, an entry field, a dropdown menu, etc.), and may be automatically implemented by the computer system upon further gathering and weighting of asset data over multiple geographic locations.

Furthermore, the computer system can present the user interface frontend 2800 having an internal advertisement spend breakdown section 2812 that indicates various internal advertising metrics, such as impressions, clicks, sales, CPI (cost per impression), CPC (cost per click), and CPS (cost per sale). The user interface frontend 2800 further includes a vehicle spend distribution section 2814 providing a graphical representation of the distribution of vehicles among the various spend categories (or inventory resource allocation levels). The user interface frontend 2800 shown in FIG. 28 further includes a problems section 2816 where problems determined to be present in one or more advertisements are communicated to users to facilitate corrective action. To the extent a user does not provide direct input to each of these categories, the computer system machine learning algorithm/artificial intelligence can automatically adjust the same consistent with trends and patterns observed for each particular asset, or class of assets in various geographic locations in real-time.

Thus, in at least one example, the computer system 100 processing module (e.g., executed within processor 102) can comprise an artificial intelligence or other algorithmically driven processing module that receives upwards of thousands or even millions of “views” in real-time from one or multiple different geographic locations (e.g., remote system(s) 112) at a time for a particular asset, and processes each view for each of multiple different categories and weights applied to each category to determine automatically whether the asset is in an appropriate resource allocation category, such as “high spend,” “medium spend,” “low spend,” and “no spend.” In real-time, the computer system can continually score each asset as each view of hundreds, thousands, or millions of views are received, and automatically re-allocate the designation for a given asset or class of vehicles in real-time based on a calculation of some or all of the views received.

Thus, when an end user opens the interface 200 on a first day, the computer system 100 may display through the display interface (i.e., showing overview section 200) that a particular asset has been categorized by the computer system as a “high spend” allocation based on the nature, weight, and amount of views received for that asset. As previously discussed, this calculation may be based on thousands or millions of views from different geographic locations at the same for the same vehicle, including data corresponding to the age of the vehicle. Then, on a next day, the user may be presented through the same interface an automatically-directed change in resource allocation of the asset to a “medium spend,” “low spend,” or even “no spend” category based on the computer's automatic and real-time computation of each or all of the views (e.g., each data point associated with the view locally, regionally, or even globally).

Thus, in at least one implementation, the computer system 100 is continually updated with new information, and can continually improve its analysis and categorization of vehicles in the different high, medium, and low categories without user input. The ability for the computer system 100 to accurately place assets into the different spend categories can be continually speed up and/or improved by virtue of each newly, learned input received by the machine learning algorithm. In particular, the machine learning algorithm executed at the computer system 100 may even make multiple different category changes for an asset in a single day based on continually received view data in one or more locales.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer system for controlling inventory-specific resource allocation, the system comprising:
one or more processors; and
one or more computer-readable recording media that store instructions that are executable by the one or more processors to configure the system to:
for each particular inventory item of a set of inventory items:
determine a plurality of evaluation score deltas corresponding to a plurality of inventory dimensions of an asset retrieved from a plurality of geographic locations, the plurality of inventory dimensions comprising at least a number of user views and age of the asset, wherein determining the plurality of evaluation score deltas of the asset comprises:
updating a machine learning algorithm executed by the system using the plurality of evaluation deltas for the asset, wherein updating the machine learning algorithm includes weighting the plurality of evaluation score deltas for the asset in real-time, and determining based on the weighting that an asset qualifies for a first asset allocation threshold;
receiving a plurality of new evaluation score deltas corresponding to the plurality of inventory dimensions of the asset and updating the machine learning algorithm to determine, based on a weighting by the machine learning algorithm of the new evaluation score deltas that the asset qualifies for a second asset allocation threshold that is different from the first asset allocation threshold;
display on a display screen the first asset allocation assigned to the asset after receipt by the system of the plurality of inventory dimensions of the asset; and
without input from an end user of the system, the one or more machine learning algorithms of the system automatically changing the display screen to show that the asset is assigned to the second asset allocation threshold.

2. The computer system of claim 1, wherein a views weight for determining the views evaluation score delta is based on a default views weight and/or a user-defined views weight.

3. The computer system of claim 1, wherein determining the plurality of evaluation score deltas further comprises:
defining an age evaluation score delta for the plurality of evaluation score deltas based on the age for the particular inventory item and an age weight, wherein the age weight is selected based on the age for the particular inventory item.

4. The computer system of claim 1, wherein the plurality of inventory dimensions further comprises one or more of leads, appointments, and condition of the inventory item.

5. The computer system of claim 4, wherein determining the plurality of evaluation score deltas further comprises:
if the age of the particular inventory item fails to satisfy the turnover age threshold, determining a leads threshold for the particular inventory item based on a function of the age for the particular inventory item and an expected leads metric;
if the age of the particular inventory item satisfies a turnover age threshold, determining the leads threshold for the particular inventory item based on the expected leads metric and not based on the function of the age for the particular inventory item;
accessing a leads metric for the particular inventory item;
if the leads metric fails to satisfy the leads threshold, defining a leads evaluation score delta for the plurality of evaluation score deltas as a weighted ratio of the leads threshold to the leads metric; and
if the leads metric satisfies the leads threshold, defining the leads evaluation score delta for the plurality of evaluation score deltas as a negative weighted ratio of the leads metric to the leads threshold, wherein a leads weight for determining the leads evaluation score delta is based on a default leads weight and/or a user-defined leads weight.

6. The computer system of claim 4, wherein determining the plurality of evaluation score deltas further comprises:
accessing an appointments metric for the particular inventory item;
if the appointments metric fails to satisfy an appointments threshold, defining an appointments evaluation score delta for the plurality of evaluation score deltas as an appointments weight, wherein the appointments weight is based on a default appointments weight and/or a user-defined appointments weight;
if the appointments metric satisfies the appointments threshold, defining the appointments evaluation score delta for the plurality of evaluation score deltas as a negative appointments weight; and
if the age of the particular inventory item fails to satisfy the turnover age threshold, reducing the appointments evaluation score delta.

7. The system of claim 5, wherein determining the plurality of evaluation score deltas further comprises:
accessing a condition label for the particular inventory item; and
defining a condition evaluation score delta for the plurality of evaluation score deltas based on the condition label and a condition weight, wherein the condition weight is based on a default condition weight and/or a user-defined condition weight.

8. The system of claim 1, wherein determining the plurality of evaluation score deltas further comprises:
determining a local scarcity and a national scarcity for the particular inventory item based on one or more labels associated with the particular inventory item;
if the local scarcity is less than an average local scarcity, defining a scarcity evaluation score delta for the plurality of evaluation score deltas as a weighted ratio of the local scarcity to the average local scarcity;
if the local scarcity is greater than or equal to the average local scarcity, defining the scarcity evaluation score delta for the plurality of evaluation score deltas as a negative weighted ratio of the local scarcity to the average local scarcity;
if the national scarcity is less than an average national scarcity, modifying the scarcity evaluation score delta by adding a weighted ratio of the national scarcity to the average national scarcity; and
if the national scarcity is greater than or equal to the average national scarcity, modifying the scarcity evaluation score delta by subtracting a weighted ratio of the national scarcity to the average national scarcity, wherein a scarcity weight for determining the scarcity evaluation score delta is based on a default scarcity weight and/or a user-defined scarcity weight.

9. The system of claim 1, wherein determining the evaluation score for the particular inventory item comprises modifying an initial evaluation score with the plurality of evaluation score deltas.

10. The system of claim 1, wherein a user interface frontend displays an inventory resource allocation level determined for each particular inventory item of the set of inventory items.

11. A computer-implemented method for controlling inventory-specific resource allocation based on scarcity data of an inventory item at a remote location, the method comprising:
for each particular inventory item of a set of inventory items:
determining a plurality of evaluation score deltas corresponding to a plurality of inventory dimensions of an asset retrieved from a plurality of geographic locations, the plurality of inventory dimensions comprising at least a number of user views and age of the asset, wherein determining the plurality of evaluation score deltas of the asset comprises:
updating a machine learning algorithm executed by a computer system using the plurality of evaluation deltas for the asset, wherein updating the machine learning algorithm includes weighting the plurality of evaluation score deltas for the asset in real-time, and determining based on the weighting that an asset qualifies for a first asset allocation threshold;
receiving a plurality of new evaluation score deltas corresponding to the plurality of inventory dimensions of the asset and updating the machine learning algorithm to determine, based on a weighting by the machine learning algorithm of the new evaluation score deltas that the asset qualifies for a second asset allocation threshold that is different from the first asset allocation threshold;
displaying on a display screen the first asset allocation assigned to the asset after receipt by the system of the plurality of inventory dimensions of the asset; and
without input from an end user of the computer system, the machine learning algorithm of the computer system automatically changing the display screen to show that the asset is assigned to the second asset allocation threshold.

12. The method as recited in claim 11, further comprising:
determining the plurality of evaluation score deltas, determine the evaluation score for the particular inventory item using the plurality of evaluation score deltas, and
determining an inventory resource allocation level for the particular inventory item based on the evaluation score using one or more artificial intelligence modules.

13. The method as recited in claim 11, further comprising:
configuring the machine learning algorithm to, for each particular inventory item of the set of inventory items:
determine the plurality of evaluation score deltas,
determine the evaluation score for the particular inventory item using the plurality of evaluation score deltas, and
determine an inventory resource allocation level for the particular inventory item based on the user input received at a user interface frontend.
